(19) United States
(12) Patent Application Publication
(10) Pub. No.: US 2021/0224936 A1
(43) Pub. Date: Jul. 22, 2021

(54) WEB BASED REAL ESTATE TRANSACTION MANAGEMENT PLATFORM AND METHODS

(71) Applicant: A LISTR INC., Toronto (CA)

(72) Inventors: Amira DEJANOVIC, Toronto (CA); Alexey PONOMAREV, Ottawa (CA); Matthew Alexander WILEY, Ottawa (CA)

(21) Appl. No.: 17/154,974

(22) Filed: Jan. 21, 2021

Related U.S. Application Data
(60) Provisional application No. 62/963,701, filed on Jan. 21, 2020.

(51) Int. Cl. G06Q 50/16; G06Q 30/06

(52) U.S. Cl. CPC G06Q 50/167; G06Q 30/0641; G06Q 30/0278; G06Q 30/0631; G06Q 30/0627

(57) ABSTRACT

This application concerns a web based portal for facilitating real estate related transactions between buyers, sellers and service providers.

### FIELD OF THE INVENTION

The present invention relates generally to the field of online market spaces for real estate. More specifically, it relates to a web based transaction management platform, which comprises a set of features that assists sellers and buyers by streamlining the transaction process and related activities.

### BACKGROUND

The cost of residential real estate has risen significantly in the last decade since the financial crisis of 2007/2008, particularly in major North American urban centres. Coupled with relatively high realtor commission rates charged by the traditional real estate brokerages and their agents, consumers have increasingly sought alternative, less expensive methods of marketing, selling and purchasing homes.

Consumers have continued to assume precarious levels of debt (e.g. mortgages, credit cards, lines of credit) in order to finance sharply increasing home prices and ownerships costs to the extent that bank regulators and thus banks have been forced to impose “stress-test” lending requirements prior to issuing loans, in part due to the lessons of the subprime lending crisis that occurred in the US in 2007/2008.

While a number of on-line, technology based tools have emerged to allow home buyers and sellers to manage the transaction process without brokers and agents (known generically as For Sale by Owner—“FSBO” methods), the majority of tools are being used to generate sales leads for existing brokers and agents as opposed to reducing transaction costs and improving transparency for buyers and sellers. As a result, real estate commissions have remained essentially constant at approximately 5% over the past 10 to 15 years.

In addition, the Canadian Real Estate Association (CREA) has been able to effectively exert monopoly control over the marketing of residential properties due to the Multi-Listing Services portal (MLS), and the provincial licensing requirements for broker/agents. The MLS portal is only fully accessible to accredited brokers and realtors for listing purposes, and the database behind the portal, which contains all historical transaction data regarding prior sales, is not widely available to the public unless requested through an accredited broker/agent. Some regions of the US are more open to competition and the provision of data to non-brokers, but challenges remain for “disruptors” seeking to develop alternative solutions to the transaction process.

For buyers, a study has shown that finding the right property, understanding the property transaction and documentation process, and obtaining a mortgage were among the most difficult parts of the home-buying process.

Since a home tends to be the largest single asset for most individuals and families, the financial implications of investing in a home can be significant and yet consumers are left essentially to their own devices to understand how such a major decision can impact them for many years beyond the actual transaction closing. As housing affordability continues to become a major concern in Canada and other parts of the developed world, over-extended consumers that may meet “stress test” rules today are increasingly at risk of major adverse impacts should there be significant corrections in economic conditions underlying real estate values. (perhaps move to the front/combine with preamble

There is also an extremely diverse and expansive range of vendors and real estate service providers whose services relate to both pre- and post-property transactions. However, their ability to connect with prospective buyers and sellers involved in a real estate transaction remains challenging, fragmented and inefficient and in many cases reliant on the traditional brokers for referrals. Also, there is limited ability for buyers and sellers to leverage these emerging services and evaluate the competence, efficacy and value of a given service provider, as has been done in the travel (e.g. Expedia), entertainment (Netflix), transportation (Uber) and consumer goods areas (Amazon).

Combined, these factors have significantly limited homeowners from marketing their own properties, and have limited the ability of prospective buyers to make highly informed decisions about potential home acquisition opportunities.

Prior art real estate transaction processes remain highly fragmented with multiple participants at each stage, providing asymmetric information to the different parties involved, while being expensive and largely out of the control of the principals to the transaction. There is therefore a need for a seamless, simple, fully integrated platform that provides buyers and sellers of residential real estate with direct participation and transparency in all steps of the real estate transaction, leading to both lower overall real estate transaction costs for the participants while also dramatically improving the experience for all parties—both buyers and sellers.

Despite rapid advancements in technology and a number of real estate targeted applications, there is not yet an integrated, efficient, accessible and centralized tool for the entire transaction life cycle of a property transaction, including the financial implications for both buyers and sellers.

A recent 2018 study by the National Association of Realtors found that 44% of all US homebuyers looked for properties online as a first step in their search process, a figure that increases with younger generations. However, the majority of existing tools put very little emphasis on identifying the key attributes being sought by buyers, and on the ranking and matching of these criteria, which could greatly reduce the search time and effort for buyers and sellers.

Given the financial significance of home ownership in a person's/family's life, combined with a general lack of significant financial literacy of many people, there is therefore a need for a simple, easy-to-use, on-line “tool” that can be employed to facilitate any decision-making process in real estate related transactions.

### SUMMARY

An object of the present invention is to provide a web based real estate transaction management platform and method. In accordance with an aspect of the present invention, there is provided a web based real estate transaction management platform comprising: a property database containing information regarding one or more property listings, wherein the property listings include properties for sale, properties for rent or both; a service database containing information regarding one or more real estate related services, wherein the property database and the service database are maintained on a central real estate transaction management computer system; at least one user module connected to the property database and the service database via a computer network for access by a user via a graphical user interface on a web page displayed on a remote computer, wherein the user is a seller, a buyer or a service provider; wherein the user module comprises at least one seller dashboard configured to display on, the graphical user interface, information relating to the current status of seller driven real estate related transaction events in progress, and at least one buyer dashboard configured to display on the graphical user interface information relating to the current status of buyer driven real estate related transaction events in progress; wherein the computer processor is operative with the property database, the service database, and the at least one user module to process inputs received via the at least one user module and to process communications via the computer network between the at least one user module and the databases; wherein the platform is configured to facilitate communication between the seller and the buyer over the computer network, and wherein the seller is a vendor or a landlord, and wherein the buyer is a purchaser or a renter.

### BRIEF DESCRIPTION OF THE FIGURES

Further features and advantages of the present invention will become apparent from the following detailed description, taken in combination with the appended drawings, in which:

FIG. 1 illustrates steps of a process for a real estate transaction, from the perspective of a seller, in accordance with one embodiment of the invention.

FIG. 2 illustrates steps of a process for a real estate transaction, from the perspective of a buyer, in accordance with one embodiment of the invention.

FIG. 3 illustrates steps of a process for the first steps of a real estate transaction, from the perspective of a seller, in accordance with one embodiment of the invention.

FIG. 4 illustrates how the information provided to a seller can be organized into a seller dashboard, in accordance with one embodiment of the invention.

FIG. 5 illustrates steps of a process for intermediate steps of a real estate transaction, from the perspective of a seller, in accordance with one embodiment of the invention.

FIG. 6 illustrates the final steps of a real estate transaction, from the perspective of a seller, in accordance with one embodiment of the invention.

FIG. 7 illustrates how the information regarding the closing process, provided to a seller, can be organized into a seller dashboard, in accordance with one embodiment of the invention.

FIG. 8 illustrates steps of a process for the first steps of a real estate transaction, from the perspective of a buyer, in accordance with one embodiment of the invention.

FIG. 9 illustrates steps of a process for intermediate steps of a real estate transaction, relating to banking, from the perspective of a buyer, in accordance with one embodiment of the invention.

FIG. 10 illustrates steps of a process for further intermediate steps of a real estate transaction, from the perspective of a buyer, in accordance with one embodiment of the invention.

FIG. 11 illustrates how the information provided to a potential buyer, can be organized into a buyer dashboard, in accordance with one embodiment of the invention.

FIG. 12 illustrates steps of a process for further intermediary steps of a real estate transaction, from the perspective of a buyer, in accordance with one embodiment of the invention.

FIG. 13 illustrates how the information regarding the closing process, provided to a buyer, can be organized into a buyer dashboard, in accordance with one embodiment of the invention.

FIG. 14 illustrates a graph showing the past and projected valuation of a property, as can be shown from a user dashboard, in accordance with one embodiment of the invention.

FIG. 15 illustrates a method to recommend valuation estimates for a listed property, in accordance with one embodiment of the invention.

FIG. 16 illustrates a method for providing a seller or buyer with a ranked list of service providers, in accordance with one embodiment of the invention.

FIG. 17 illustrates a method of the present invention to provide sellers with recommendations as to improvements that will assist them in realizing maximum net proceeds for their homes, in accordance with one embodiment of the invention.

FIG. 18 illustrates a method of the present invention for facilitating a potential buyer's decision as to affordability, in accordance with one embodiment of the invention.

FIG. 19 illustrates a method of the present invention to present the buyer with a list of properties having the buyer's criteria, in accordance with one embodiment of the invention.

FIG. 20 is a screenshot of a Buyer's Guide page of the real estate management platform, in accordance with one embodiment of the invention.

FIG. 21 is a screenshot of a Buyer's Guide page of the real estate management platform, platform, in accordance with one embodiment of the invention.

FIGS. 22 to 38 are screenshots of the steps carried out by a user to generate a real estate listing using the web portal of the real estate management platform, in accordance with one embodiment of the invention.

FIG. 39 is a screenshot of a web page with a seller dashboard that displays the status of real estate transactions being managed by a user using the platform, in accordance with one embodiment of the invention.

FIGS. 40 to 42 are screenshots of web pages relating to a buyer initiated search of the property database, in accordance with one embodiment of the invention.

FIGS. 43 and 44 are screenshots of web pages displaying calendars generated using user dashboards, in accordance with one embodiment of the invention.

FIG. 45 is a screenshot of a web page displaying a seller dashboard, displaying the status of real estate transactions being managed by the seller, in accordance with one embodiment of the invention.

FIG. 46 is a screenshot of a web page displaying the offer portal of a buyer dashboard, in accordance with one embodiment of the invention.

FIG. 47 is a screenshot of a web page displaying a notification page of a seller dashboard, in accordance with one embodiment of the invention.

FIGS. 48 and 49 are screenshots of web pages displaying a seller dashboard, and information related to a pending offer, in accordance with one embodiment of the invention.

FIG. 50 is a screenshot of a web page displaying a notification page of a buyer dashboard, in accordance with one embodiment of the invention.

FIGS. 51 to 69 are screenshots of web pages displaying the step-by-step process for generating a purchase agreement using the portal of the present invention, in accordance with one embodiment of the invention.

FIG. 70 is a screenshot of a payment page, in accordance with one embodiment of the invention.

FIGS. 71 to 73 are screenshots of web pages displaying the web portal accessing the information regarding service providers maintained on the service database, in accordance with one embodiment of the invention.

FIG. 74 is a screenshot of a web page displaying the web portal for requesting a sale sign from the service database, in accordance with one embodiment of the invention

FIG. 75 is a screenshot of a web page on the service provider dashboard accessed by a service provider to generate a service provider listing using the web portal of the real estate management platform, in accordance with one embodiment of the invention.

FIGS. 76 and 77 are screenshots of web pages relating to filming location rentals maintained on the property database, in accordance with one embodiment of the invention.

### DETAILED DESCRIPTION

Embodiments of the present invention relate to an online, integrated platform, which connects buyers and sellers of real estate assets and related products and services, in such a way as to facilitate their respective tasks in the transaction process, thereby facilitating the transaction as a whole. Embodiments of the present invention are described below.

Embodiments of the present invention include a web based real estate transaction management platform, represented by a web portal designed as a fully-integrated, step-by-step, highly automated and intuitive process which incorporates a series of submodules that facilitate and optimize multiple aspects of a real estate transaction. In particular, the platform accepts data from each participant in a real estate related transaction, for example, sellers of property and potential buyers, into a database, and processes the data contained in the database to provide the participants with various recommendations regarding: value range/affordability, pre- and post-transaction financial implications, improvements to listings, improvements to properties/buyer preferences, financing or mortgage proposals, potential/recommended service providers and other elements that are required to complete a real estate related transaction. The present invention optimizes the efficiency of an online real estate related transaction.

Embodiments of the present invention can include the use of a computing device by each participant in the transaction, along with common consumer hardware, the internet, and a web portal, which is accessible by any of the users. The web portal that is required to implement the methods of the present invention can also herein be referred to as the market place, the market space, the website, the software or the system.

Embodiments of the present invention can include all or some of the following methods, presented to users sequentially, together, or some in sequence and in any combination, such as to match the regular steps that are required to complete a real estate related transaction.

Embodiments of the platform of the present invention provide an integrated and simplified approach to the entire real estate transaction process and the life-cycle associated with home ownership. For example, instead of starting at “Property Search” as most of today's online portals do, the portal of the present invention, in a preferred embodiment, provides a customer-centred web portal as the hub for all or many real estate related transactions and activities pre- and post-closing, thus providing the user with direct control over financial planning and lifestyle decisions, given a real estate property tends to be most families' largest single asset (initial and ongoing cash outlay, investment decision driver etc.).

The portal of the present invention allows the participants in the transaction (e.g., a seller, a buyer, or a renter) to execute real estate related transactions by use of web-based tools, in addition to providing access to a wide range of resources for all or many aspects of pre- and post-transaction activities.

In one embodiment, the present invention is an integrated platform that connects buyers and sellers of real estate assets and providers of related products and services, placing control of these transactions in the hands of the participants. The present platform uses a powerful combination of “best of breed” technology, real estate statistics and relevant data analytics/artificial intelligence (A.I.) methods and to create a seamless and easy to use platform that gives consumers far greater visibility into the transaction process, costs and service levels/performance, without requiring the involvement of an intermediary realtor or agent.

In one embodiment, the platform of the present invention takes the seller/buyer through the entire or most of the sale process—step by step—from the potential sale of the current home to the purchase/rental of a new home and the financial implications of such a transaction (e.g., net cash proceeds, lower/higher carrying costs of new home, more/less monthly cash flow available, and the like), as well as facilitating interactions with service providers as required or desired through each stage of the process.

As used in the present disclosure, the term “seller” is used to describe the party to a real estate related transaction who may be selling a property (i.e., a vendor), or who is renting a property (i.e., a landlord).

As used in the present disclosure, the term “buyer” is used to describe the party to a real estate related transaction who may be purchasing a property (i.e., a purchaser), or may be renting or leasing a property (i.e., a renter or tenant).

As used in the present disclosure, the term “real estate property” is used to describe any property that may be sold, rented or otherwise transferred or shared between parties, and may include, but is not limited to, residential homes, apartments, apartment buildings, retail and office spaces, warehouses, condominiums, recreational properties, agricultural properties, and film location rental properties.

As used in the present disclosure, the term “real estate related transaction” is used to describe any transaction related to the sale or rental of a real estate property, including the sale or rental of the property, and the provision of any service related to or facilitating the sale or rental.

As used in the present disclosure, the term “service provider” is used to describe a party to a real estate related transaction who is providing one or more real estate related services to facilitate a real estate related transaction. This can include, but is not limited to, financial service providers, legal service providers, contractors, tradesmen such as plumbers, electricians, painters, roofer and the like, utility service providers, moving companies, vehicle rental companies, providers of marketing resources such as photographers, For Sale sign suppliers, stagers and the like, landscaping companies, home inspectors, and insurance providers.

As used in the present disclosure, the term “real estate related service” is used to describe a service that facilitates a real estate related transaction. This can include, but is not limited to, financial services, legal services, contracting services, trades plumbing, electricals work, painting, roofing and the like, utility services, moving services, vehicle rentals, marketing resources, landscaping, home inspection services, and insurance.

The present invention provides a web based real estate transaction management platform comprising a property database containing information regarding one or more property listings, wherein the property listings include properties for sale and/or rent, and a service database containing information regarding one or more real estate related services, wherein the property database and the service database are maintained on a central real estate transaction management computer system.

The real estate transaction management platform is accessed through a user module, which is connected to the property database and the service database via a computer network. The platform is accessed via a graphical user interface on a web page displayed on a remote computer. The user module comprises at least one seller dashboard configured to display on the graphical user interface information relating to the current status of seller driven real estate related transaction events in progress, and at least one buyer dashboard configured to display on the graphical user interface information relating to the current status of buyer driven real estate related transaction events in progress.

The graphical user interface therefore displays information according to the needs of the user, which may display a seller dashboard, a buyer dashboard, or a combination of the two if the user is engaging the platform as both a buyer and a seller. The dashboards are dynamic and responsive to information input by the users, and reflect the current status of a transaction at each step of the process. Certain aspects of each dashboard will therefore change, appear or recede depending on the status of a transaction process.

The dashboards are configured to display information relating to the current status of various aspects of transactions in progress. For example, a dashboard will be updated as relevant property listings of interest are added. The seller dashboard may display information pertinent to the interests of the seller, such as information relating to their properties listed in the property database, or communications with potential buyers or service providers. In a similar manner, the buyer dashboard may display information pertinent to the interests of the buyer, such as a list of properties of interest, or communications with potential sellers or service providers. The respective dashboards are therefore updated to reflect interactions and correspondence between buyer and seller, so that each participant in the transaction has the current status for each transaction in their respective display, providing an indication of tasks completed or requiring further action.

In one embodiment, the user module further comprises least one service provider dashboard configured to display on the graphical user interface information relating to the current status of service provider driven real estate related transaction events in progress, wherein the service provider uses the service provider dashboard to input information regarding one or more services provided into the service provider database and to correspond with the buyer or seller who is requesting a service.

The platform also comprises a computer processor operative with the property and service databases and the user modules to process data inputs received via the user module and to process communications via the computer network between the user module and the databases.

The present invention therefore provides a seamless, simple, fully integrated platform that provides all parties to a real estate related transaction with direct participation and transparency in all steps of the real estate transaction, leading to both lower overall real estate transaction costs for the participants while also dramatically improving the experience for all parties, including buyers, sellers and service providers.

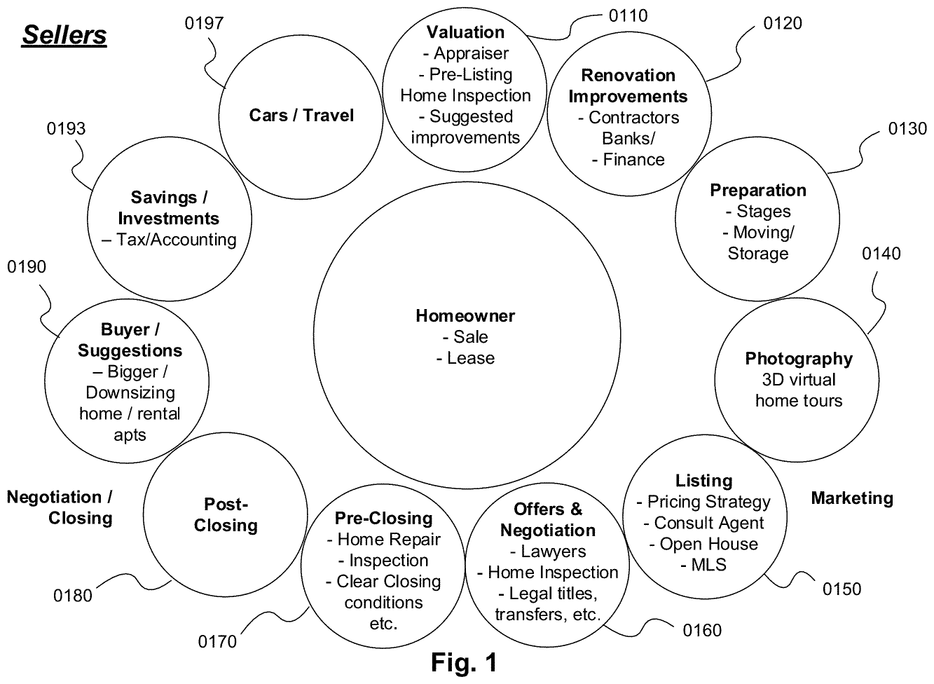

FIG. 1 illustrates, in an embodiment of the present invention, the steps that a seller may be offered or required to act upon, before, during, and after a transaction.

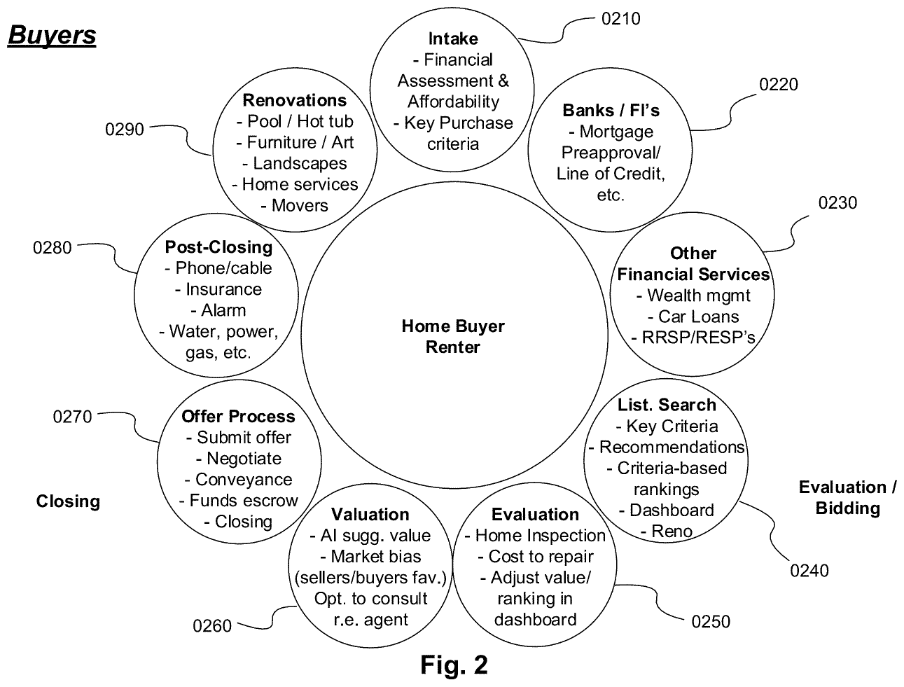

FIG. 2 illustrates, in an embodiment of the present invention, the steps that a buyer may be offered or required to act upon, before, during and after a transaction.

In one embodiment, the platform of the present invention facilitates the real estate transaction by carrying out one or more steps of the valuation process using information regarding one or more of the following criteria:
Artificial Intelligence (“AI”) suggested value price based on home facts, market conditions, location and specific user submitted data/value drivers (e.g. renovations completed, upgrades, age of HVAC equipment, appliances, etc.)
Standardized data captured for the listing to assist buyers with assessment and diligence.
Access to MLS/local real estate board data essential to gather historical pricing data for the specific property, comparable neighbourhood properties, relative balance between buyers/sellers in the area, and users who have identified the specified area of interest etc.
Physical/expert appraisal, if requested can be recommended to appraise a seller's home for a professional home valuation.

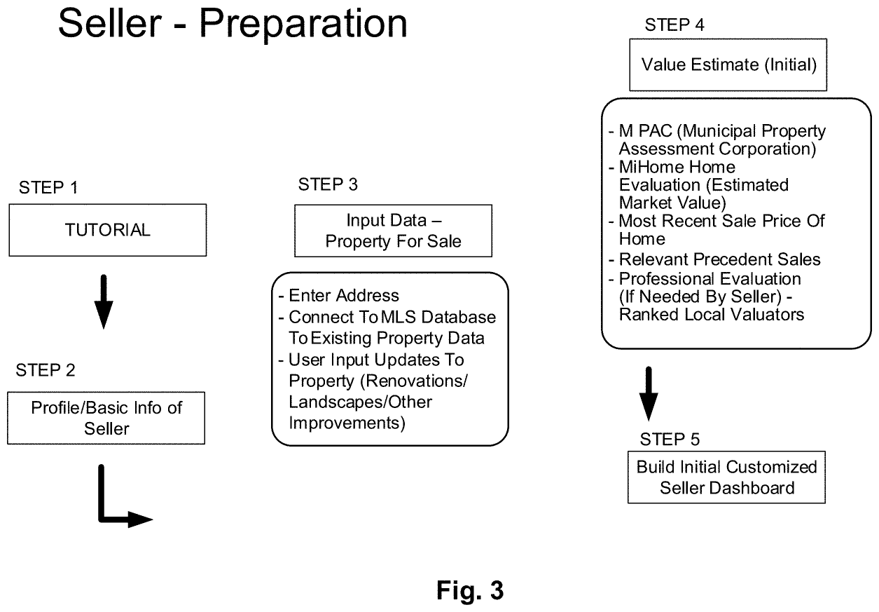

An embodiment of the above steps is represented in the Valuation submodule 0110 of FIG. 1, and in greater details in FIG. 3.

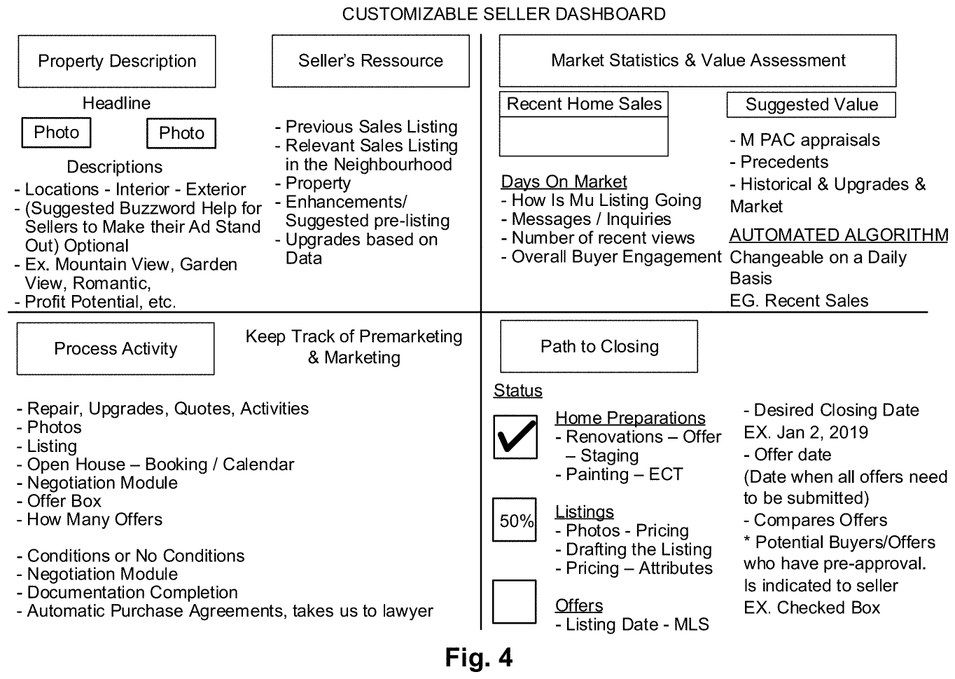

In one embodiment of the invention, the seller's entry of information for the valuation process can result in the creation of seller dashboard, which displays information regarding the transaction process. FIG. 4 illustrates an embodiment of such a dashboard.

In one embodiment, the platform of the present invention facilitates real estate related transactions by arranging for engagement of service providers, such as for home inspections, renovations, and the like as represented in the Improvement submodule 0120 of FIG. 1. In such an embodiment, local ranked home inspectors may be selected from service providers in the service database to visit the homeowner, provide a comprehensive review of the home and recommend potential repairs and improvements prior to listing the home such as, but not limited to: upgrades to the electrical system, replacement of appliances, painting, and structural repairs. In one embodiment, the final inspection report would be made available via the platform through the buyer dashboard to prospective buyers to provide them with assurances regarding the general condition of the home.

In one embodiment, the platform of the present invention facilitates the real estate transaction by identifying or recommending actions for preparing the home for sale, as represented in the Preparation submodule of 0130 of FIG. 1. In one embodiment, the platform recommends actions such as landscaping, painting, minor renovations, etc., according to buyers' preferences. In one embodiment, identification of service providers to carry out these actions is displayed on the seller dashboard.

In one embodiment, the platform provides comparative sales data that will assist sellers to realize maximum net proceeds for their homes (e.g. by advising that a renovated kitchen for $x/square foot yields $2x/square foot in realized sale proceeds based on relevant market data, or by advising how many homes recently sold in the area had renovated kitchens). In one embodiment, the comparative sales data is maintained on the service database.

In one embodiment, the platform of the present invention facilitates the real estate transaction by providing estimates for costs associated with making improvements to the home in response to a query from the seller via the seller dashboard, whereby the relevant information stored in the service database is accessed and displayed on the seller dashboard. In one embodiment, a list of service providers who can carry out the recommended improvements is displayed on the seller dashboard. In one embodiment, one or more service providers obtained from the service database in response to a seller query are engaged to provide an estimate by the seller using the platform.

In one embodiment, the platform recommends local contractors, painters, electricians, landscapers, home stagers, and the like, based on criteria set out in the seller query.

In one embodiment, the seller can create, using the platform, a “request for quotation” for the work to be performed, to include timing and pricing commitments.

In one embodiment, the platform of the present invention facilitates the real estate transaction by providing access to 3D virtual tours of the home. Once the home is ready to be photographed for the listing, a 3D virtual tour of the home, as represented in the Photography submodule 0140 of FIG. 1, is generated and can be made available for viewing by a buyer using the buyer dashboard on the platform so the potential buyer can view the home as though they were walking through it. In one embodiment, the platform can be used to send out a “request for quotation” automatically to a short list of recommended photographers stored in the service database.

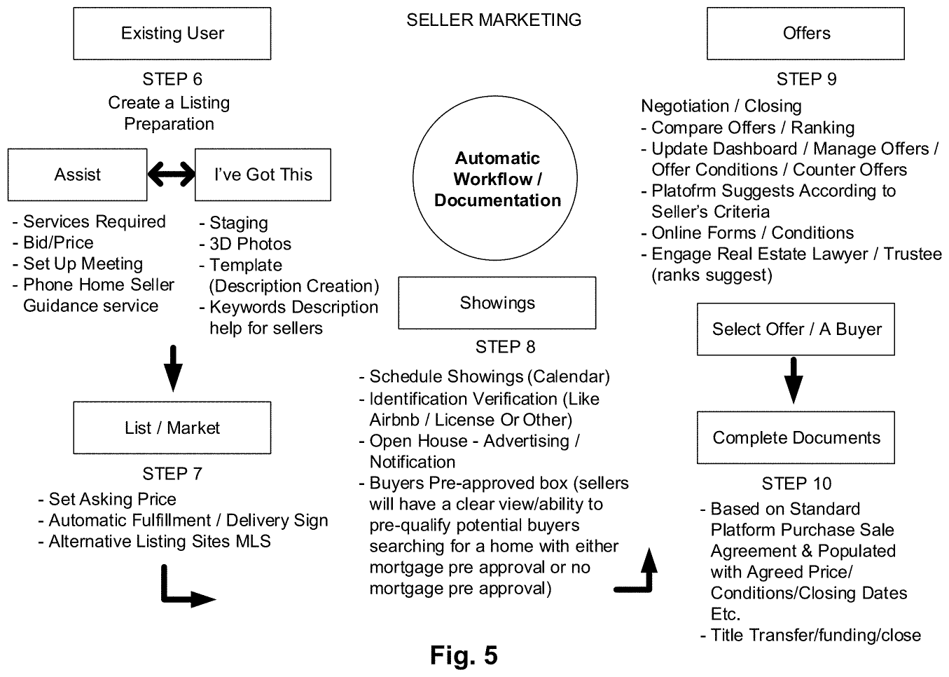

In one embodiment, the platform of the present invention facilitates real estate related transactions by providing access to in-house resources and “sellers help” marketing guidelines to assist sellers to maximize the impact of their listing and homes, and make them more attractive to potential buyers. These steps are among those of the Listing submodule of 0150 of FIG. 1, and FIG. 5 illustrates a more detailed embodiment of the steps in sequence. These services are obtained by submitting a query to the service database via the seller dashboard.

In one embodiment, the platform of the present invention facilitates real estate related transactions by arranging for delivery and installation of an artistically designed “For Sale” sign, open house times and “Sold” sticker for the seller.

In one embodiment, the platform of the present invention facilitates the real estate transaction by enabling sellers to create their own listings, upload photos, 3D Virtual tours, advertising, and marketing in an easy, step by step process to the property database using existing data, such as tax roll and city data, MLS data, prior listing information, updated details regarding renovations or additions, and the like. The information may be uploaded to the property database automatically from existing public databases, or manually by the seller via the seller dashboard.

In one embodiment, the present platform provides means for automatically uploading to the property database specific information and attributes about the area or location, such as walking scores and others, based on information obtained from A.I., proprietary databases, and other resources.

In one embodiment, the platform generates a listing activation to automatically notify potential buyers who are active users or members on the present platform and who have identified criteria that match the listing. The process of information transfer, viewing, and further pre-transaction steps then commences.

In one embodiment, the platform of the present invention facilitates the real estate transaction by informing the user about activity and interest around the listing via information presented on the seller's dashboard, accessible through the platform. This information may include one or more of number of views, quality of views, depth of information sought, listing impact on prospective buyers, and more, thus enabling the seller to assess the impact of the listing. Provided in real-time, the information can also help the seller assess whether any adjustments need to be made in the price or other conditions of the real estate property.

In one embodiment, the platform of the present invention facilitates the real estate transaction by scheduling showings based on seller availability. In one embodiment, the seller, using the seller dashboard, posts a calendar identifying viewing availability which can be viewed using the buyer dashboard. The buyer can then send a message through the buyer dashboard to the seller, selecting one or more viewing slots, and the seller can in turn confirm the appointment.

In one embodiment, the platform of the present invention facilitates the real estate transaction by pre-qualifying potential buyers via a credit check, authentication, etc., prior to scheduling a viewing appointment.

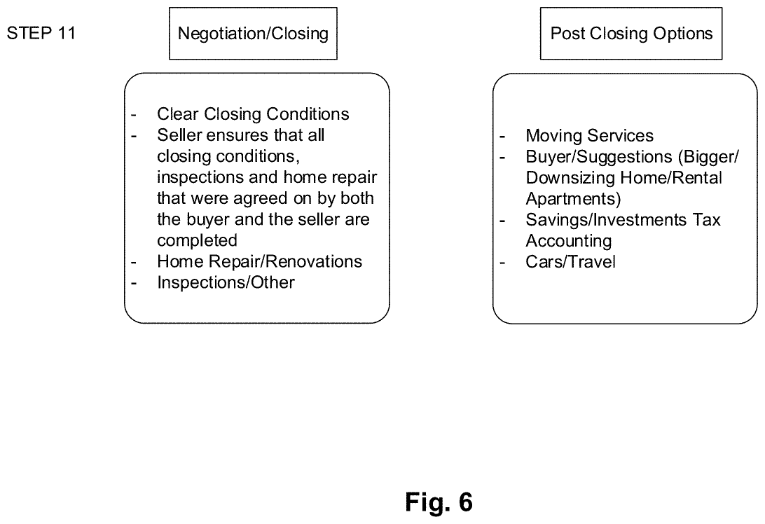

In one embodiment, the platform of the present invention facilitates the real estate transaction by providing a negotiating portal. In one embodiment, the portal is used to submit or receive offers, to negotiate a transaction, to allow a certain amount of time for negotiating a deal, and to make adjustments to pricing and other conditions. In one such embodiment, the buyer submits an offer through the buyer dashboard to be posted on the seller dashboard. The seller can, in turn, submit a response to the buyer's offer through the seller dashboard. Embodiments of these steps are incorporated in the Offers & Negotiation submodule of 0160 of FIG. 1, one of which is illustrated in FIG. 6.

In one embodiment, the platform of the present invention facilitates the real estate transaction by providing, upon request of the buyer and/or seller though their respective dashboards, a ranked list of user recommended real estate lawyers to help negotiate the transaction, document the transaction, provide due diligence support ensuring there are no title or other legal issues, help with closing, and to prepare documentation relating to legal titles, transfer, conveyancing, proof of financing, and other relevant matters. In one embodiment, a list of law service providers is maintained on the service database.

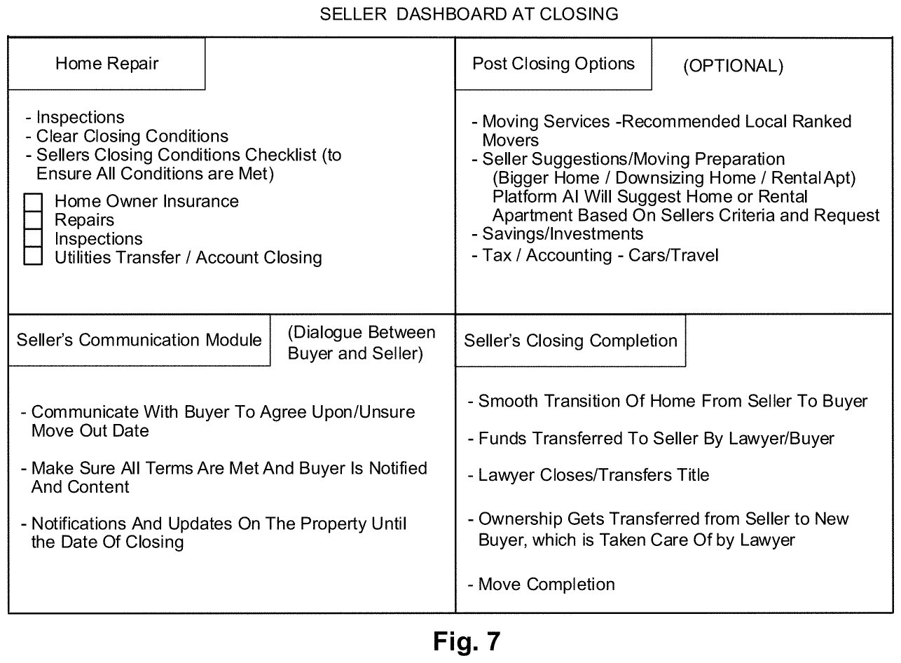

In one embodiment, the platform of the present invention facilitates real estate related transactions by providing assistance with closing and post-closing tasks. These steps are incorporated in the Pre-Closing submodule 0170 and Post-Closing submodule 0180 of FIG. 1. FIG. 7 illustrates an embodiment of the seller's dashboard listing events associated with the closing process. In one embodiment, the platform provides a ranked list of local or available movers, contractors, HVAC providers, plumbers, electricians, etc., based on their reputation and track record. The platform also facilitates quote and scheduling requests. The list of service providers and associated information is maintained in the service database.

In one embodiment, the platform generates a schedule of signing and/or closing dates, and generates associated documentation, such as a purchase agreement. This can be done with or without a lawyer, and be facilitated with workflow tools automating the documentation output.

In one embodiment, the portal can provide, using available and additional buyer data, post-closing services to the new homeowner, including but not limited to: financial and budgeting advice regarding future real estate purchases, other investments, and car and travel expenses. These features are represented in the Buyer/Suggestions submodule 0190, the Savings/Investment submodule 0193, and the Cars/Travel submodule 0197 of FIG. 1. This information is maintained in the service database.

FIG. 1 illustrates, in an embodiment of the present invention, the steps that a buyer may be offered or required to act upon, before, during, and after a transaction.

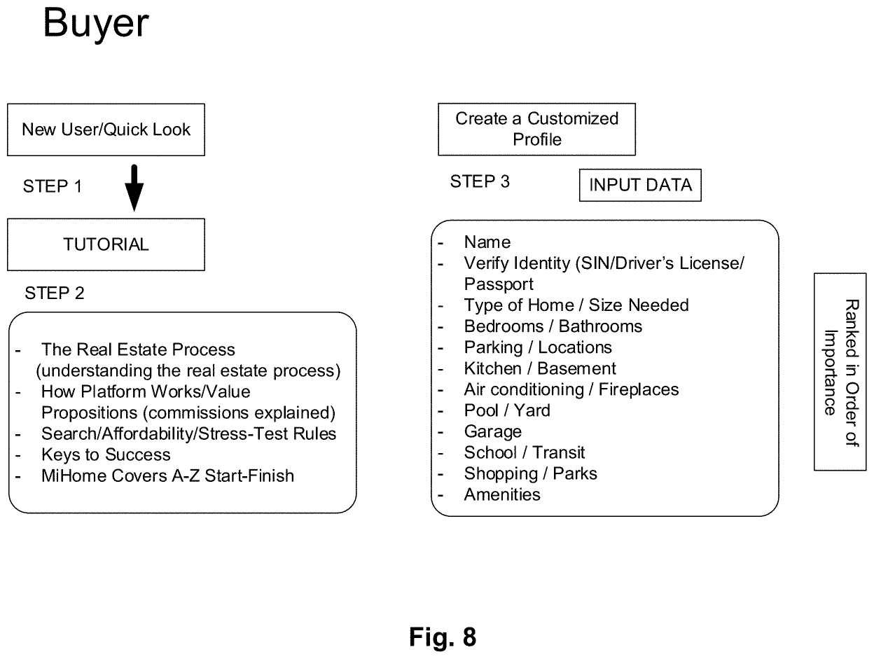

In one embodiment, the platform of the present invention facilitates the real estate transaction by providing a comprehensive financial overview based on the buyer's financial data and costs associated with a real estate property, to produce a personalized determination of both purchase affordability and monthly cost of ownership. This can include estimated taxes, maintenance fees, utilities, and the like which is associated with the home price range and preferred location, which may be maintained in the property database. FIG. 8 illustrates an embodiment of the present invention wherein the buyer provides personalized information to the platform through the buyer dashboard. This also corresponds to the Intake submodule 0210 of FIG. 2.

In one embodiment, the platform can act as the core financial tool in the users toolkit, given the home ownership component is likely the largest and most impactful on all other aspects of a person's finances over the course of his/her lifetime. In such an embodiment, the platform can recommend a price range of homes that are appropriate according to the buyer's financial information.

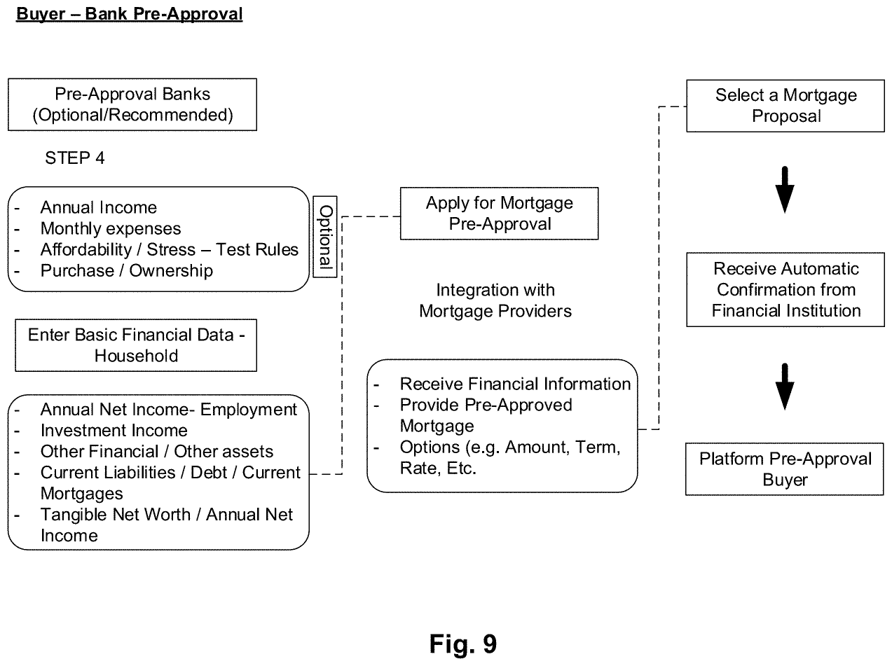

In one embodiment, the platform can automatically request mortgage pre-approval based upon verified financial information and “stress test” criteria. In such an embodiment, the platform can send information out for a “bid” in a similar manner as a mortgage broker would do, in response to a query of the service database received from the buyer via the buyer dashboard, and can automatically produce the best terms from financial institutions subscribing to the present portal. Information relating to financial services and service providers is maintained in the service database. These steps are represented in the Banking/Financial Institution (FI) submodule 0220 of FIG. 2, and one possible embodiment is illustrated in FIG. 9.

In one embodiment, the platform of the present invention facilitates the real estate transaction by providing pre-approval transparency for both buyer and seller. For example, the platform can provide checkbox verification, without the buyer having to create a PDF for seller, from a bank.

In one embodiment, the present platform can integrate other financial services, including but not limited to: wealth management, car loans, RRSP's, RESP's, TFSA's, and budgeting tools. These steps are represented in the Other Financial Services submodule 0230 of FIG. 2. Information relating to these services and service providers is maintained in the service database.

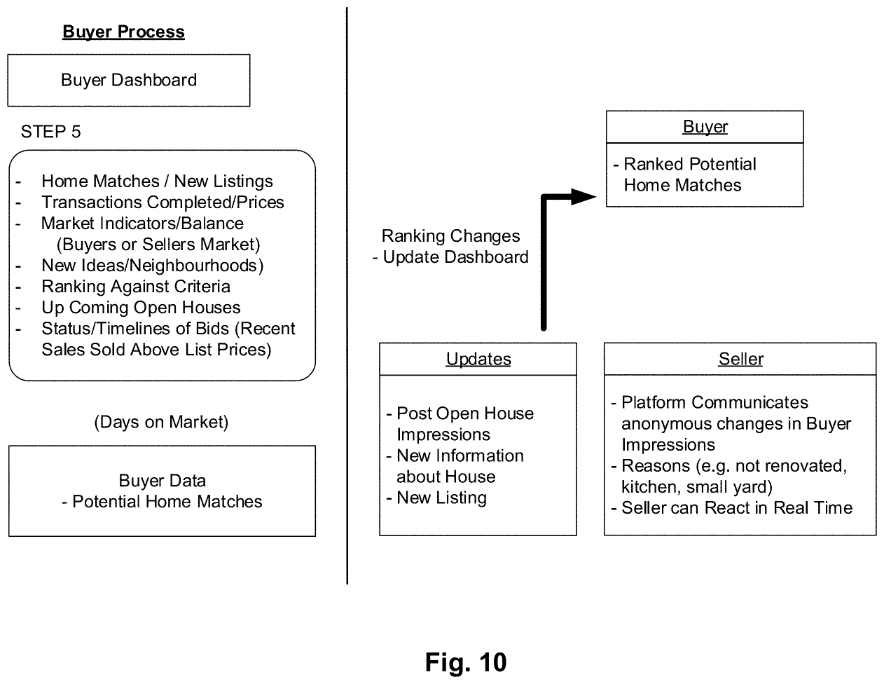

In one embodiment, the platform of the present invention facilitates the real estate transaction by providing access to searches of real estate listings maintained on the property database. In such an embodiment, search terms regarding the buyer's preferred criteria, including area of the city, type of property, size of home, price range, affordability, attributes, amenities, and the like, are entered using the buyer dashboard. These steps are represented in the Listing Search submodule 0240 of FIG. 2. FIG. 10 illustrates an embodiment of the search process from a buyer's perspective.

In one embodiment, search results are provided based on A.I. generated “Hits”, according to the buyer's criteria and ranking. In one embodiment, the platform can automatically weigh the available options based on the match vs buyer criteria.

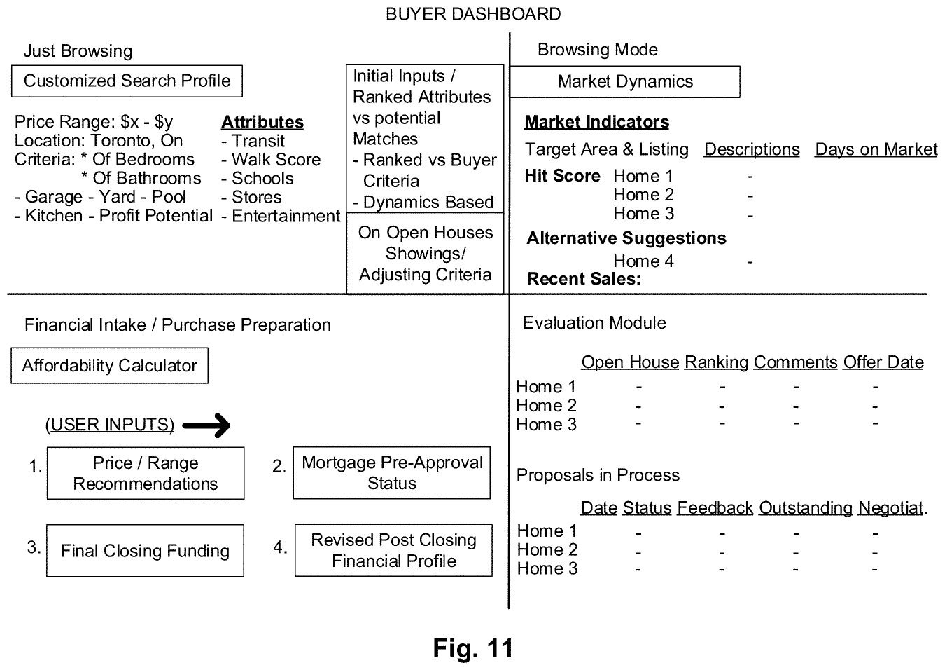

In one embodiment, the platform displays the search results to the buyer on the buyer's dashboard that becomes the buyer's key tool for tracking and managing interest in the various properties being reviewed. FIG. 11 illustrates an embodiment of a buyer's dashboard.

In one embodiment, the platform “learns” buyer preferences over time as certain homes are “accepted” or “rejected”, and as specific reasons are provided, allowing search criteria to become increasingly focused and tailored to the user.

In such an embodiment, data on “rejections” is fed back to the seller of a property, optionally on an anonymous basis, so they can understand and react as needed (e.g. kitchen is dated, unfinished basement, no parking, etc.).

In one embodiment, the platform can also suggest alternative neighbourhoods that may be outside the target criteria but match in most others (e.g. within pricing range, less competitive, larger homes available in highly ranked neighbourhoods with all requested amenities, etc.). This can be particularly useful for buyers unfamiliar with the city or locations, who are attempting to evaluate options from other regions, etc.

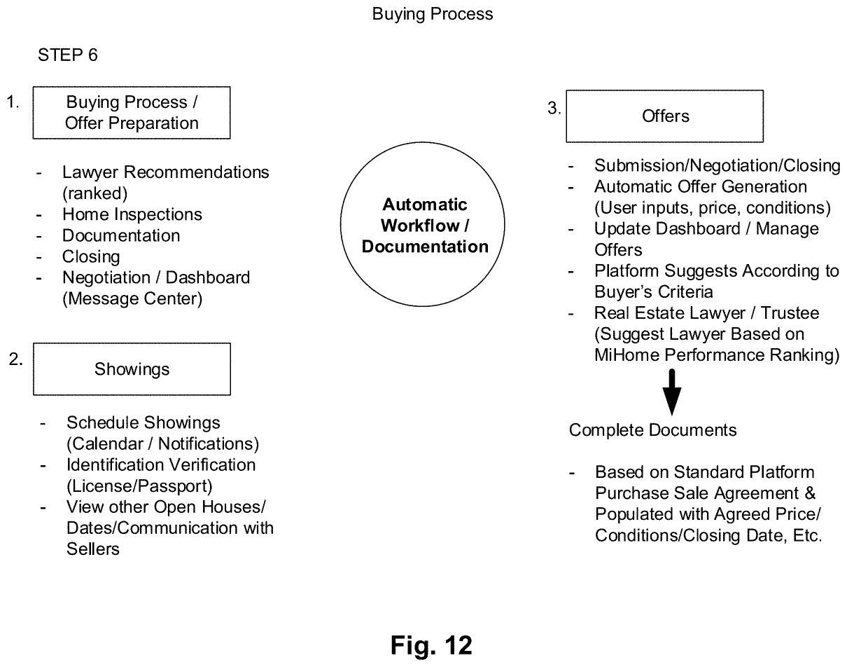

In one embodiment, the platform of the present invention facilitates real estate related transactions by providing to the buyer suggestions for ranked home inspectors, which are stored on the service database. This step is represented in the Evaluation submodule 0250 of FIG. 2, and FIG. 12 illustrates an embodiment of the buying process as a whole, from the buyer's perspective.

In one embodiment, the portal, in response to a buyer query, can also include a display of the cost to repair and/or an adjustment in value on the dashboard to bring it into scope to meet buyer criteria. Information related to repair costs may be retrieved directly from information maintained in the service database, or may be provided by service providers identified in response to a buyer query.

In one embodiment, the portal employs an A.I.-suggested value price based on home conditions (according to user data submitted to the property database) and market conditions and location. This step is represented in the Valuation submodule 0260 of FIG. 2.

In one embodiment, the platform of the present invention facilitates the real estate transaction by providing a messaging center and/or a portal for negotiations, on which a buyer, using the buyer dashboard, can communicate with a seller for any information requests (e.g. documentation regarding renovations completed, appliances purchased etc.). The request is displayed on the seller dashboard, and the requested information can be returned via the seller dashboard to the buyer for display on the buyer dashboard. This step of the process is represented in the Offer Process submodule 0270 of FIG. 2.

In one embodiment, the platform of the present invention facilitates the real estate transaction by providing a transaction time frame (showing a certain amount of time for negotiation), number of competing offers (competing offer price not disclosed) and a listing of required approvals to a buyer for negotiation, all of which may be displayed on the respective dashboards.

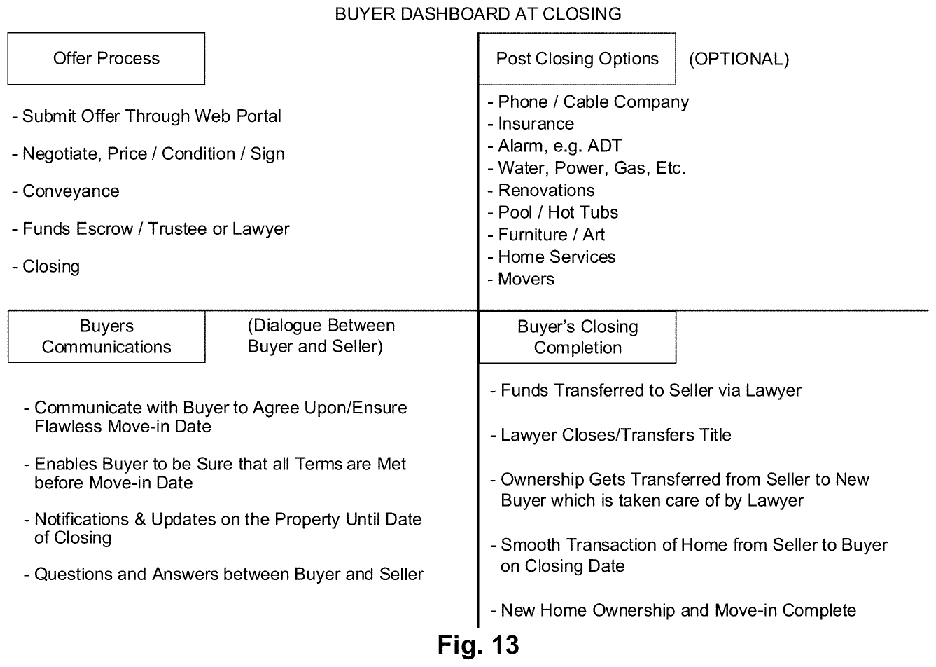

In one embodiment, the platform of the present invention facilitates the real estate transaction by providing a list of approved/user ranked real estate lawyers to complete documentation for the transaction from the service database, to ensure a smooth transaction between buyer and seller related to purchase agreements, mortgage documents, title transfer documents etc. FIG. 13 illustrates an embodiment of a buyer's dashboard, once the closing process has begun.

In one embodiment, the platform of the present invention facilitates closing of the real estate transaction, including resolution of all closing conditions between buyer and seller that are agreed upon and stated on the purchase agreement, by the closing date. In one embodiment, this includes buyer secured financing, preferably obtained via financial service providers obtained from the service database, to fund the property purchase.

In one embodiment, the platform provides a ranked list of insurance providers obtained from the service database, e.g. home insurance, auto insurance, and/or life insurance, for which quotations can be automatically generated to the buyer upon submission of a request via the buyer dashboard. These steps are represented in the Post Closing submodule 0280 of FIG. 2.

In one embodiment, the platform of the present invention facilitates the real estate transaction by suggesting local, highly ranked service providers for all post-ownership needs including, but not limited to, utilities/phone, cable, home alarm, water service, pool/hot tub companies, furniture/art, landscapers, painting, roofing, renovations, home services, movers, and/or feng shui consultants. The list of service providers is maintained in the service database. These steps are represented in the Renovations submodule 0290 of FIG. 2.

In one embodiment, the portal provides the seller of a property, a potential buyer, or both, with recommendations as to its value. Based on data/location/property inputs, the original date of purchase, and more, the platform in this embodiment can consolidate historic & forecast data (new housing starts, days listed, properties sold), and provide a “WATERLINE” graphic representation of past, present & predicted value of property. The graphic can be simple but customized for display on the dashboard to provide a clear visual representation of current market potential of home (degree of balance in the area, buyers searching in the area currently/specific search for sellers home attributes). For buyers, the data can include dynamics in the area, pricing evolution, balance/imbalance, B/W Buyers & Sellers vs other target areas.

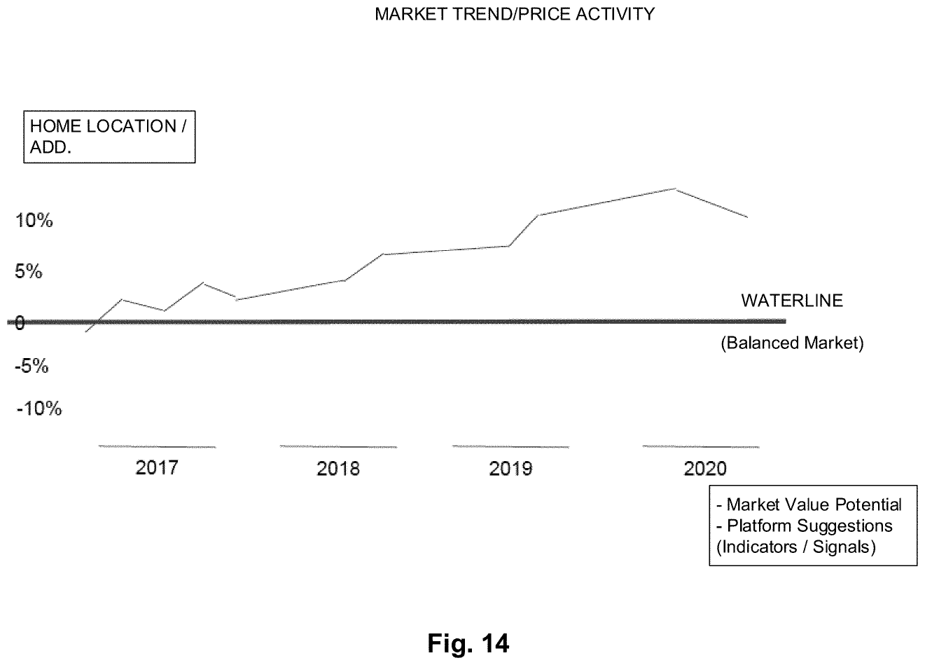

FIG. 14 illustrates an embodiment of a valuation graph that can be displayed on a seller's or a buyer's dashboard.

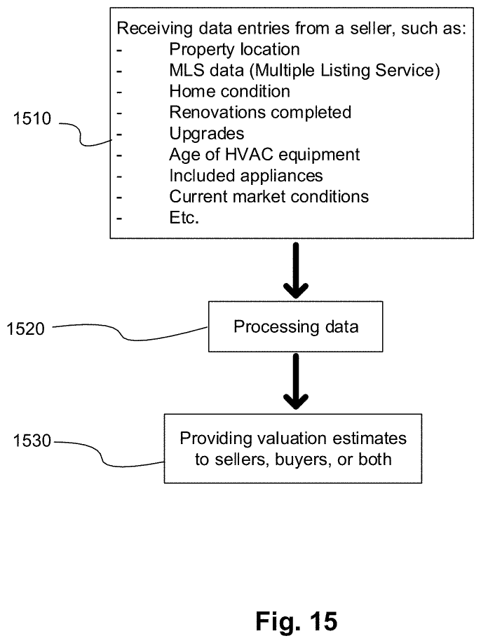

FIG. 15 illustrates a method by which value recommendations can be based on the property's location, on local real estate board or MLS data, on specific seller-submitted data such as home condition, renovations completed, upgrades, the age of HVAC equipment, included appliances, etc., and on current market conditions 1510. The data can then be processed 1520, and valuation estimates can be provided 1530 to sellers, buyers, or both on their respective dashboards.

In one embodiment, the portal presents sellers and buyers with lists of service providers that are ranked in order of client ratings. Service providers can include any combination of: appraisers, home inspectors, construction contractors, photographers, 3D photographers, utilities providers, alarm system installers, water services providers, pool suppliers, hot tub suppliers, furniture suppliers, artwork suppliers, landscaping companies, painting companies, roofing companies, home renovation companies, moving service companies, Feng Shui services, insurance brokers, lawyers, and other service providers that may be required by sellers and buyers to facilitate a real estate transaction.

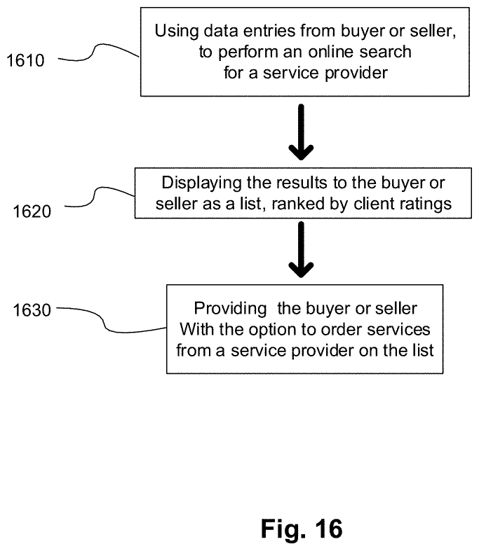

FIG. 16 illustrates a method for presenting to buyers and sellers ranked lists of service providers that feature client ratings, in accordance with an embodiment of the present invention. With this method, an online search for service providers is performed, using data entries from a buyer or seller 1610, and the results of the search are displayed to the buyer or seller as a list on their respective dashboards, ranked by client ratings 1620. The present method then provides the buyer or seller with the option to order services from a service provider on the list 1630.

In one embodiment, the portal presents the various ranked lists of service providers to sellers and buyer sequentially, together, some sequentially, and some together, or individually between any steps of the transaction, such as to be available when required, or at the appropriate step of the real estate related transaction.

In one embodiment, the portal provides sellers with recommendations as to improvements that will assist them in realizing maximum net proceeds for their properties/homes, along with quotations to have the improvements performed.

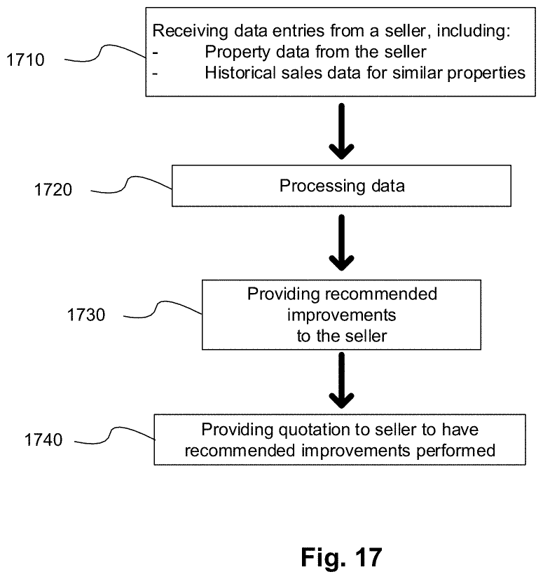

FIG. 17 illustrates a method by which sellers can be provided with recommendations as to improvements that will assist them with a sale. The method can be based on data from the seller, as well as on historical sales data for similar properties 1710. The data can then be processed 1720, and recommended improvements can be provided to the seller 1730, along with a quotation to have the improvement recommendations performed 1740.

In one embodiment, the portal provides sellers with marketing guidelines or strategies to assist them in maximizing the impact of their listing and make homes more attractive to potential buyers.

In one embodiment, the portal provides the seller with options to have a sign delivered and installed at the property. The sign can be a “For Sale” sign, a schedule of open house times, a “Sold” sticker, or another sign that can facilitate a property transaction.

In one embodiment, the portal presents to sellers and buyers with specific information about a property's area, locational attributes, walking scores, and more, based on accessible databases.

In one embodiment, the portal notifies a potential buyer when a new listing having attributes that matches the buyer's criteria is entered into the property database.

In one embodiment, the portal provides a seller with activity on a listing, that enables the seller to assess the impact of their listing, including: number of views, quality of views, depth of information sought, listing impact on prospective buyers, etc.

In one embodiment, the portal, based on buyers' activity on a listing and the listing's impact, makes real-time recommendations to the seller as to whether adjustments need to be made to the property itself, or to the property's listing.

In one embodiment, the portal provides qualified buyers and a seller with a visiting schedule or calendar to a property. The visiting schedule or calendar can be based on data entries from the buyer and the seller, and it can be updated when buyer and the seller change their time preferences.

In one embodiment, the portal allows a potential buyer to make an offer for a property, to negotiate a transaction within a certain amount of time, to make pricing and condition adjustments etc., and to be provided with the number of competing offers from other buyers for the same property.

In one embodiment, the portal generates documentation using workflow tools, and schedules a closing date.

In one embodiment, the portal provides buyers who enter their financial information and a preferred location, with a personalized determination of both purchase affordability and monthly cost of ownership. The determination can take into account estimated taxes, maintenance costs, utilities costs, etc.

In one embodiment, the portal provides buyers who enter their financial information with recommended price ranges for homes that are appropriate.

In one embodiment, the portal provides buyers who enter their financial information with appropriate property listings.

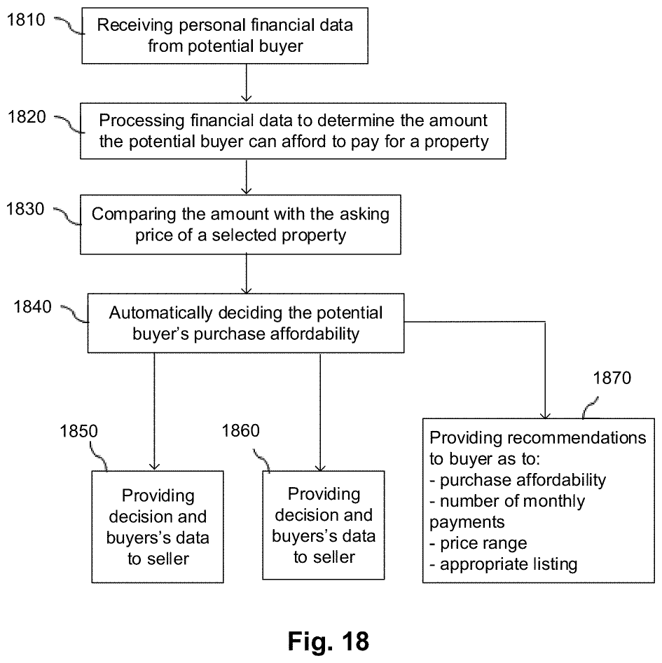

FIG. 18 illustrates a method by which the buyer and seller can be provided with documentation on whether or not a buyer is qualified by a financial institution for a pre-approved mortgage to purchase a selected property. The platform receives personal financial data from the potential buyer 1810, which can then be processed to determine the amount the buyer can afford to pay for a property 1820. In accordance with this embodiment, the amount is compared with the asking price of a selected property 1830, and an automated decision is made as to the potential buyer's purchase affordability 1840. The automated decision and the buyer's data can then be provided to the seller 1850. The decision can also be provided to the buyer 1860, and be used to provide recommendations to the buyer as to: purchase affordability, number of monthly payments, price range, and appropriate listings 1870.

In one embodiment, the portal provides buyers who enter their financial information with mortgage quotes from financial institutions, and identify the quotes having the best terms. The method can consist of sending out the financial information to subscribing financial institutions, receiving the quotes, and displaying the results to the buyer, or to both the buyer and the seller on their respective dashboards.

In one embodiment, the steps for obtaining financing approval using the portal of the present invention comprise the sequential display of a series of query prompts for the buyer on the buyer dashboard, where the buyer enters their responses to the queries using the dashboard. In an exemplary embodiment, the first query prompts selection of the type of financial service by the buyer, followed by a series of prompts for the buyer to provide information including, for example, first time buyer status, the type of property sought, the target price of the property sought, the minimum down payment to be provided, and the buyers' annual income, credit score, employment status, and bankruptcy history. The portal, upon confirmation that all necessary information has been provided, will provide a list of possible financial service providers based on the information obtained. The portal may also facilitate contact and communication between the buyer and a selected financial service provider.

In one embodiment, the portal provides pre-approval transparency for both the buyer and seller. The method can include checkbox verification, and be such that the buyer does not need to create a PDF document from the bank to the seller.

In one embodiment, the portal integrates other financial services, such as wealth management, car loans, budgeting tools, RRSPs, RESPs, TFSAs, etc.

In one embodiment, the portal can receive inputs regarding specific criteria from a buyer, entered using the buyer dashboard, including any combination of: area of the city, type of property, size of home, price range, affordability, attributes, amenities, etc., and in response, can present the buyer with a list of properties having the entered criteria.

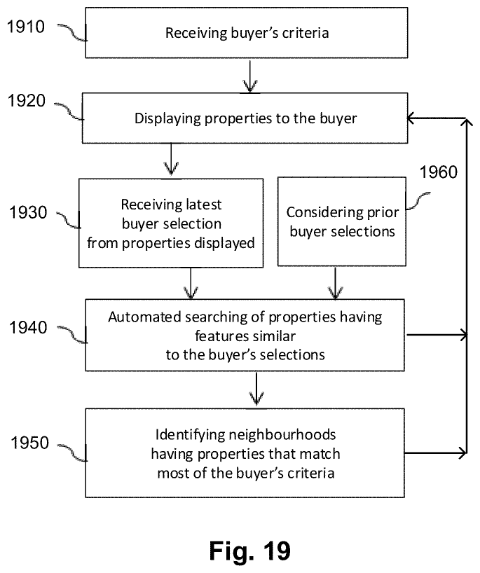

FIG. 19 illustrates a method, in accordance with an embodiment of the present invention, for displaying to buyers recommendations that match their criteria. First, the platform receives a buyer's criteria 1910. The platform then displays to the buyer properties that match the criteria 1920. The buyer can select a property from properties displayed 1930. An automated search of other properties stored in the database is then performed to identify properties having features similar to the buyer's latest selections 1940. The present method can then display these properties to the potential buyer 1920.

In one embodiment, the portal ranks the list of properties having the buyer's criteria according to how well the properties match the criteria.

In one embodiment, the portal tracks and manages the buyer's interest in the various properties according to the buyer reviews as entered using the buyers dashboard.

In one embodiment, the portal learns a buyer's preferences over time, as the buyer accepts and rejects listings displayed via the dashboard, and specifies the reasons for acceptances and rejections. The learned preferences can then be used to increasingly focus and tailor the buyer's search. FIG. 19 illustrates where a step to consider a buyer's preferences can be introduced 1950, before displaying properties to the buyer.

In one embodiment, the portal provides sellers with anonymous data on rejections, and the reasons for rejections, so that they can understand the reasons for rejections and make adjustments to their listings as needed.

In one embodiment, the portal calculates the cost to repair a property, so as to bring it into scope to meet a buyer's criteria.

In one embodiment, the portal suggests to a buyer, alternative neighbourhoods that may be outside a buyer's target criteria, but that match in most others. FIG. 19 illustrates where this can be introduced in the method to present the buyer with a list of properties having the entered criteria 1960.

In one embodiment, the portal facilitates communication between a buyer and a seller to request information.

In one embodiment, the portal facilitates completion of the property transaction without a lawyer if the buyer and seller so desire.

In one embodiment, the portal ensures that the buyer has secured financing to fund the property purchase prior to completion of the real estate transaction.

Embodiments of the present invention can also provide a method to ensure that all conditions, joint conditions and deal specific conditions between a buyer and a seller, stated on the purchase agreement, are agreed upon and met by before the transaction can close.

Embodiments of the invention described herein are exemplary and a variety of selections from the described features can be envisioned. Additionally, each feature can be embodied differently with regard to its presentation on the user interface and underlying aspects of functionality.

In accordance with preferred embodiments of the present invention, the real estate transaction management platform is implemented on computer network system, which includes a real estate transaction management computer system 16, which hosts a website and stores and processes the information entered by the user(s). Users can access and communicate with the real estate transaction management computer system via remote computer devices coupled to the computer system via a computer network, such as the Internet, or by other suitable communications means. In a preferred embodiment of the invention, the computer network comprises the Internet and remote computer devices each having a web browser application for accessing content on the World Wide Web. The remote computer device can be, by way of example, a smart phone or similar device, PDA, handheld mobile digital electronic device, tablet computer, portable computer, desktop computer or the like. Upon reading this specification, those skilled in the art will understand that, under appropriate circumstances, considering issues such as developments in computer hardware, software and connectivity, etc., other network configurations and devices also may suffice. Also in accordance with the present invention, the real estate transaction management computer system includes a central processing unit (CPU) for processing data and program instructions, as well as data storage and memory devices, as are known in the art, for storing the property and service databases. The property and service databases are used to store data required to provide the functionality described herein. The user (e.g., a buyer, a seller or a service provider), using theft respective dashboards, can access the platform through a graphical user interface displayed as a web site on the remote computer device.

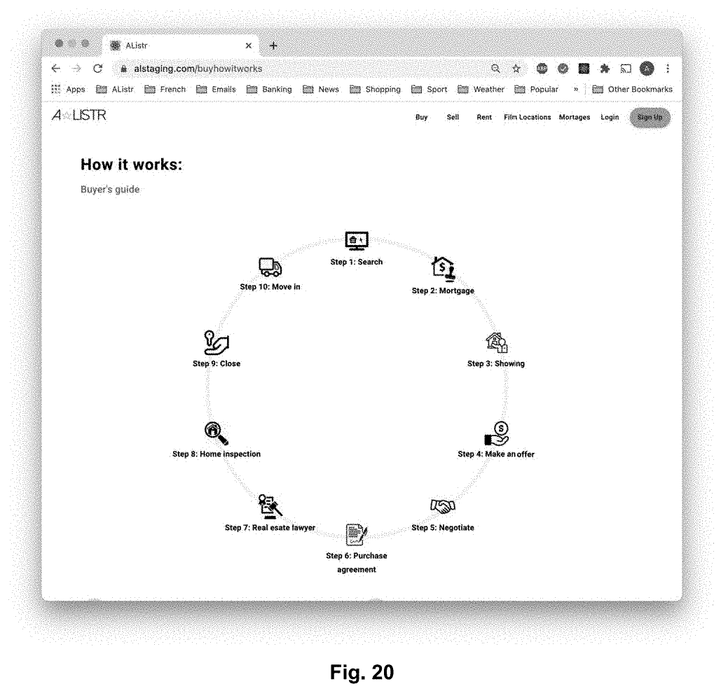

FIGS. 20 to 77 show exemplary web pages associated with the real estate transaction management portal accessible to a user on a remote computer device, through the user modules.

FIG. 20 is a screenshot of a Buyer's Guide page of the real estate management platform, providing a step by step summary of the buyer's interaction with the platform in managing all aspects of a real estate transaction from the perspective of a buyer of a real estate asset.

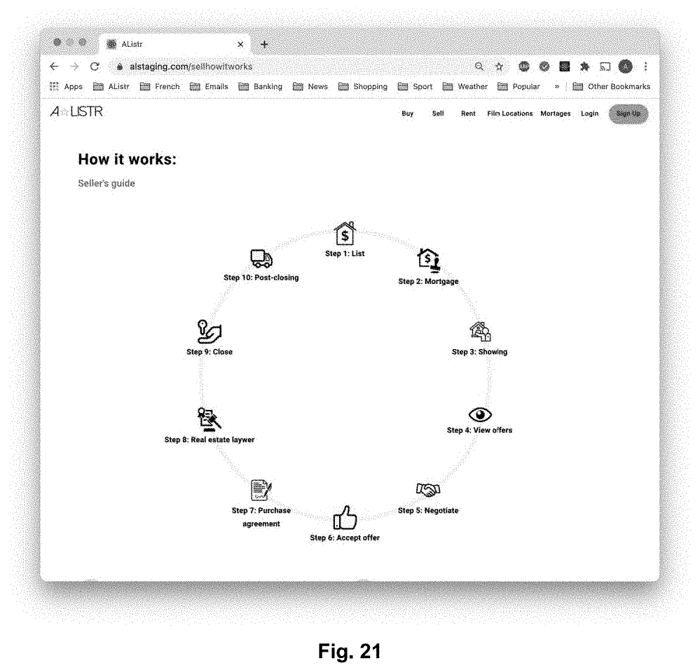

FIG. 21 is a screenshot of a Seller's Guide page of the real estate management platform, providing a step by step summary of the seller's interaction with the platform in managing all aspects of a real estate transaction from the perspective of a seller of a real estate asset.

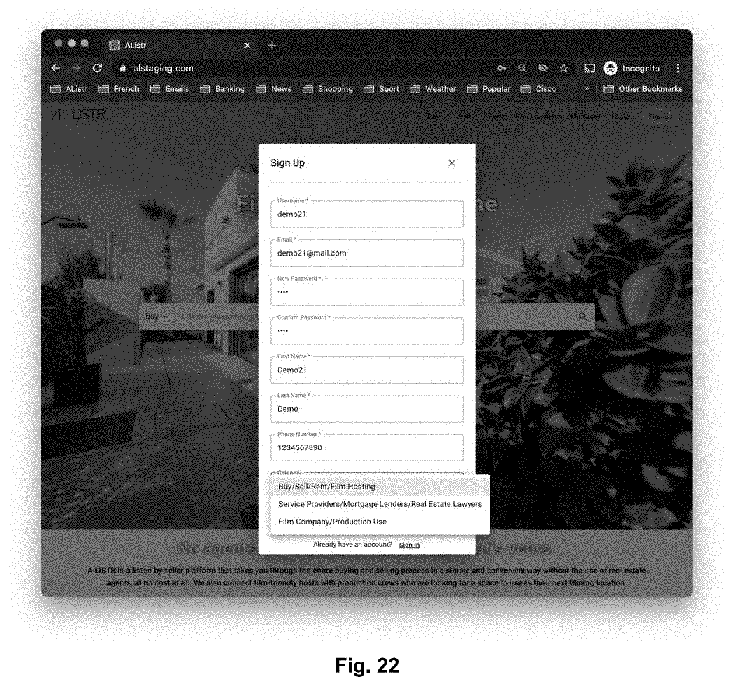

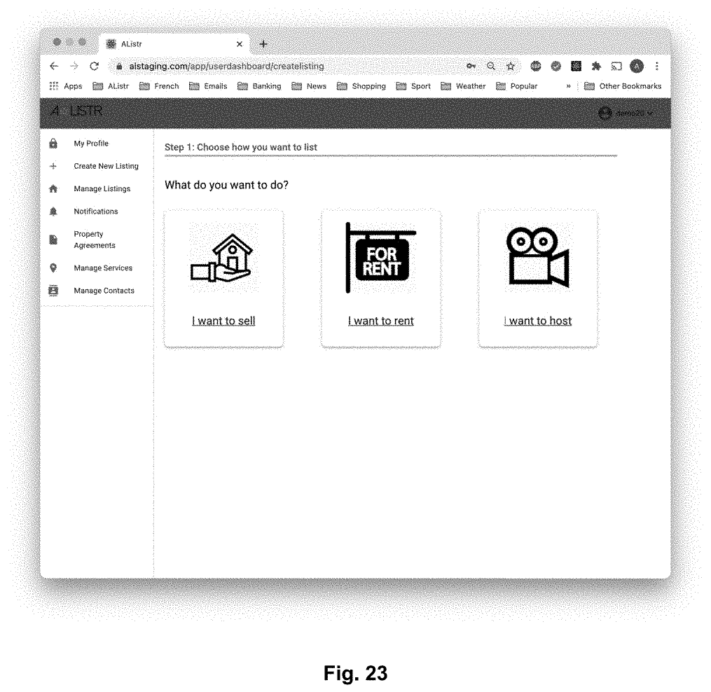

FIGS. 22 to 38 are screenshots of the steps carried out by a user to generate a real estate listing using the web portal of the real estate management platform. The platform guides the user though each step of the process, beginning with the generation of a user profile through the entry of personal information on the sign-up page (FIG. 22), including, for example, identifying whether they are an owner, a buyer or a renter of a real estate asset. The portal then queries, in a first step of the process for generating a real estate listing, the user to specify what they would like to list the real estate asset in question, for example, sell or rent it, or make it available for hosting an event (FIG. 23).

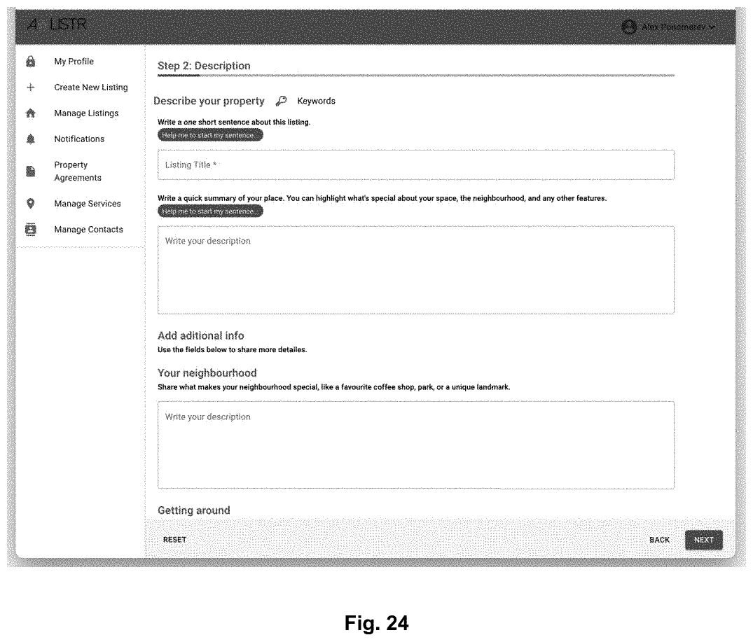

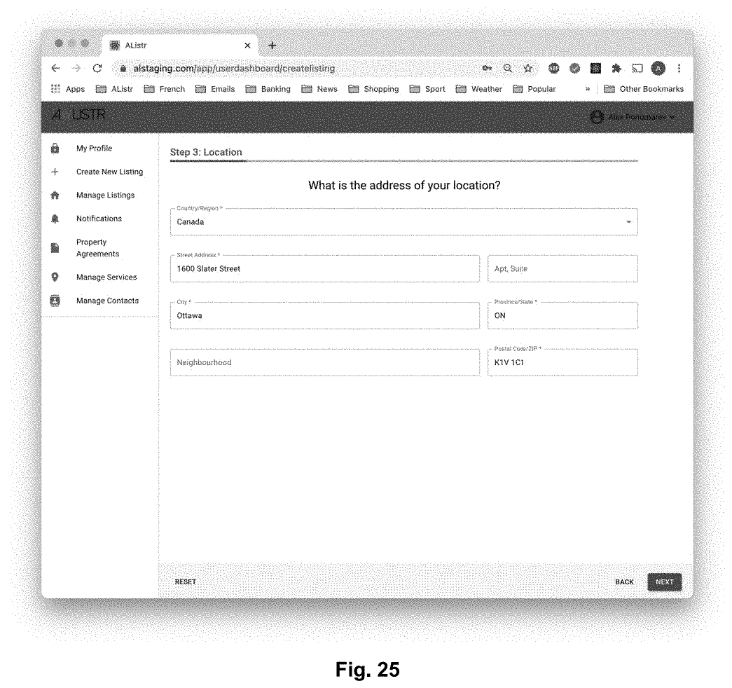

FIG. 24 is a screenshot of a web page for prompting entry, in a second step of the process for generating a listing, of a description of the real estate asset by the seller, including suggested descriptive phrases. FIG. 25 is a screenshot of a web page for prompting entry, in a third step of the process for generating a listing, information regarding the location of the real estate asset.

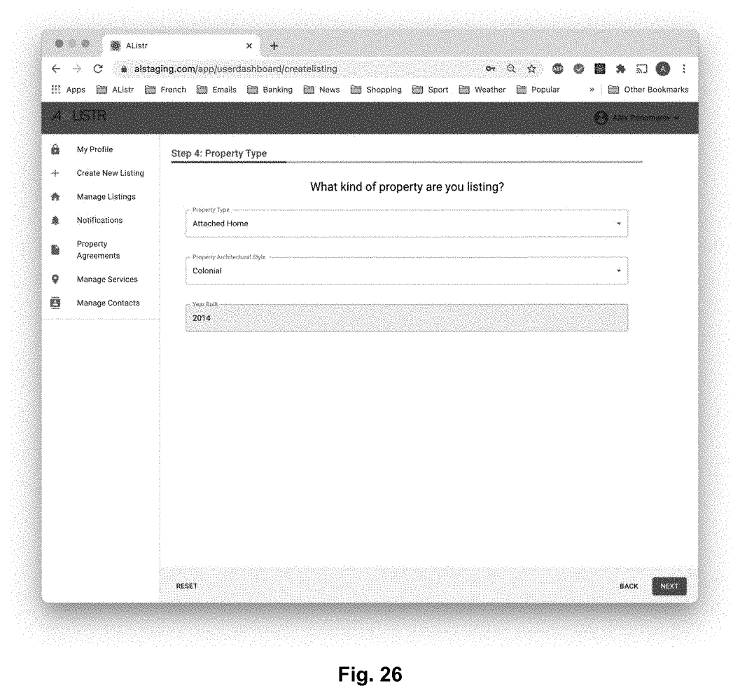

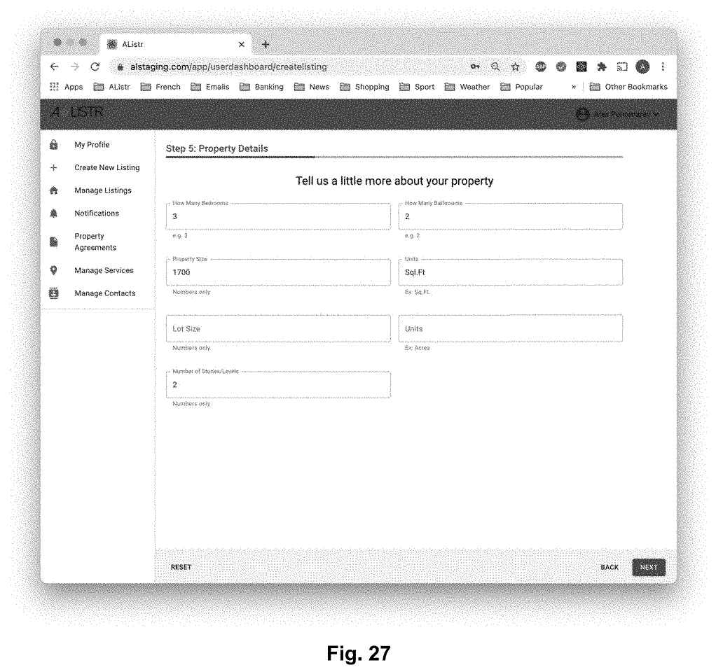

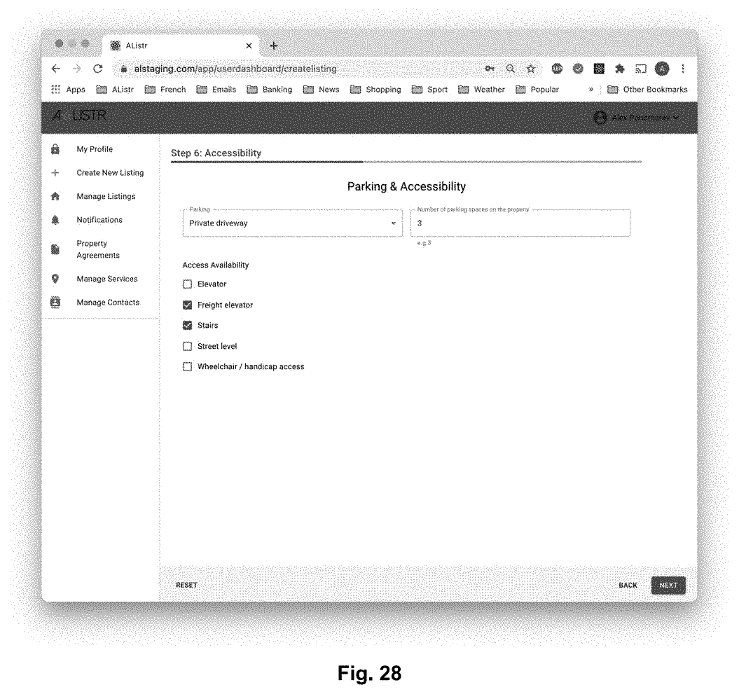

FIG. 26 is a screenshot of a web page for prompting entry, in a fourth step of the process, information regarding the type of property being listed and the year of construction, FIG. 27 is a screenshot of a web page for prompting entry, in a fifth step of the process, information regarding details of the property, for example, number of bedrooms and bathrooms, size of property, number of stories, and the like, and FIG. 28 is a screenshot of a web page for prompting entry, in a sixth step of the process, information regarding parking and accessibility.

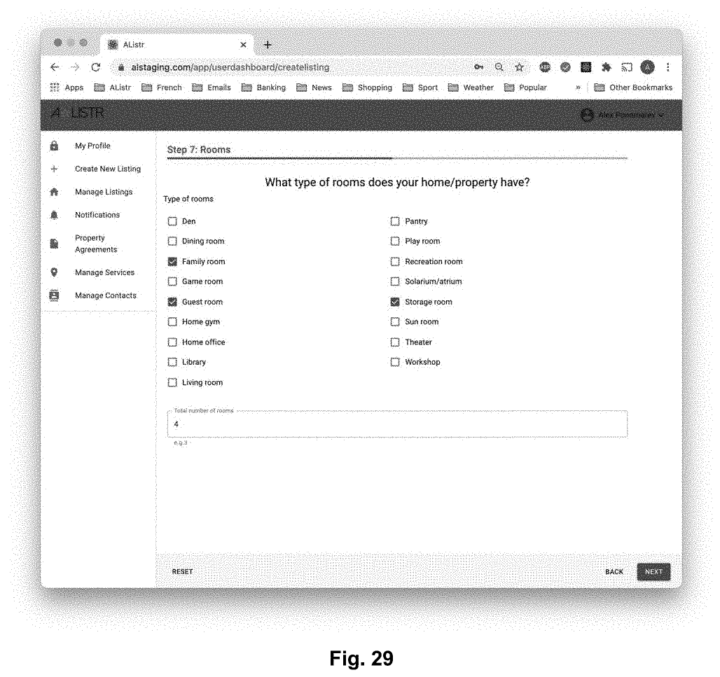

FIG. 29 is a screenshot of a web page for prompting entry, in a seventh step of the process, information regarding the types of rooms in the property,

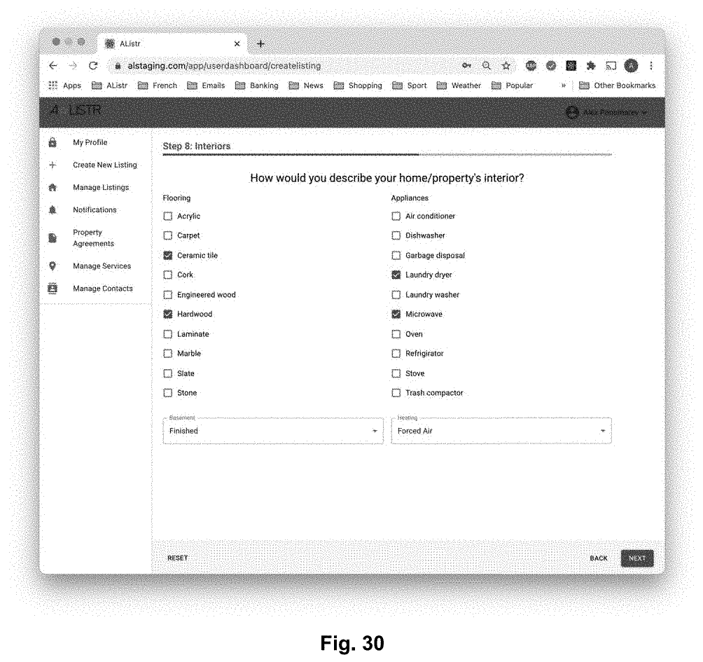

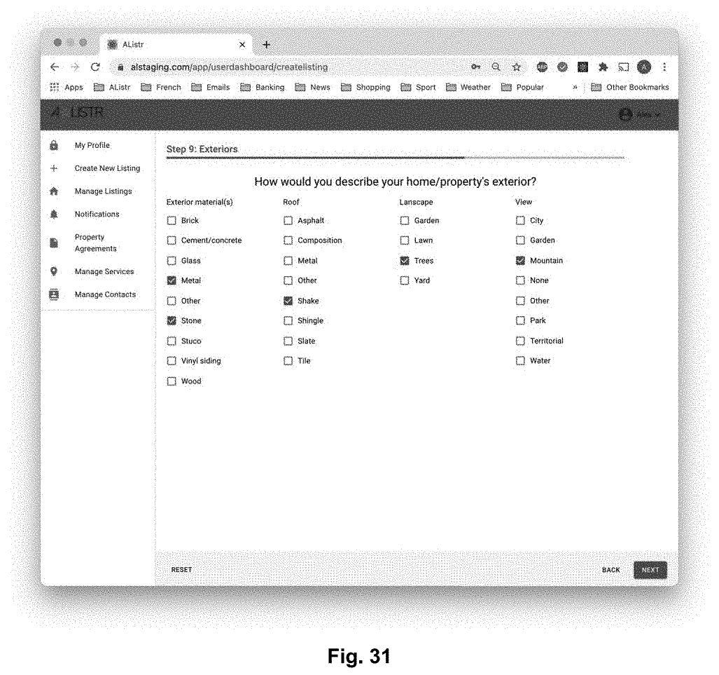

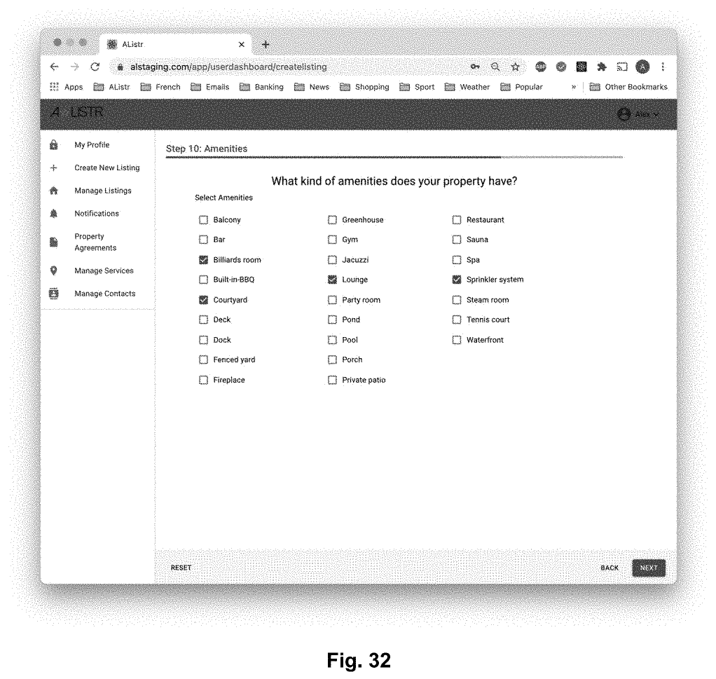

FIG. 30 is a screenshot of a web page for prompting entry, in an eighth step of the process, information regarding details regarding a description of the property's interior, for example, finishes and fixtures, FIG. 31 is a screenshot of a web page for prompting entry, in a ninth step of the process, information regarding the property's exterior, for example, finishes and landscaping features, and FIG. 32 is a screenshot of a web page for prompting entry, in a tenth step of the process, information regarding different amenities present in the property.

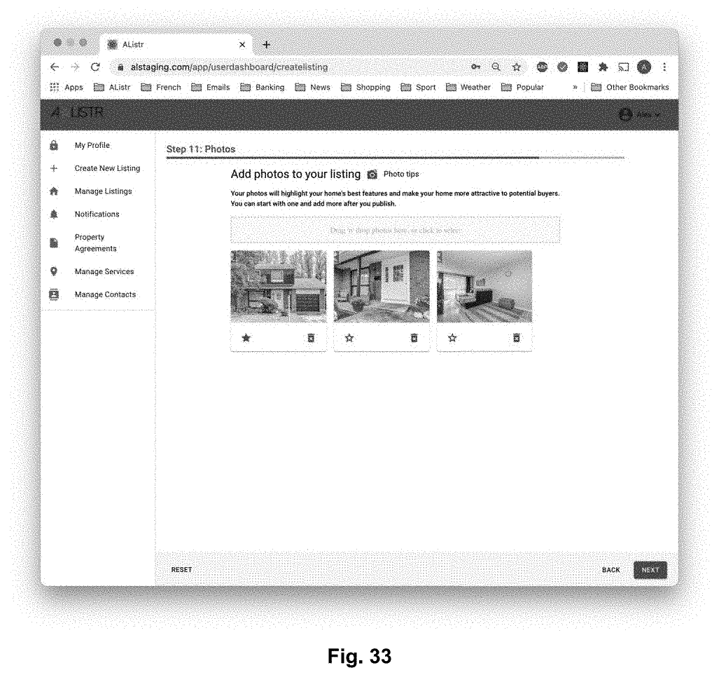

FIG. 33 is a screenshot of a web page for prompting the addition of photos of the property, in an eleventh step of the process.

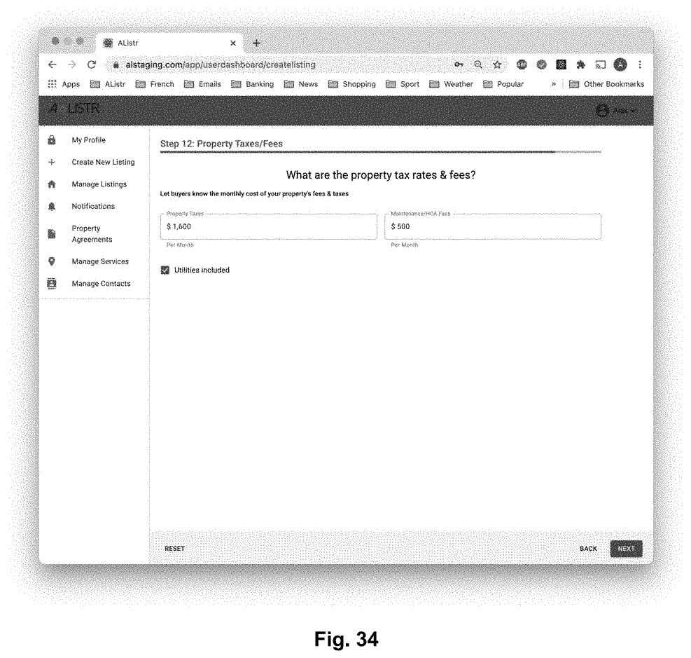

FIG. 34 is a screenshot of a web page for prompting entry, in a twelfth step of the process, information regarding property taxes and/or maintenance fees.

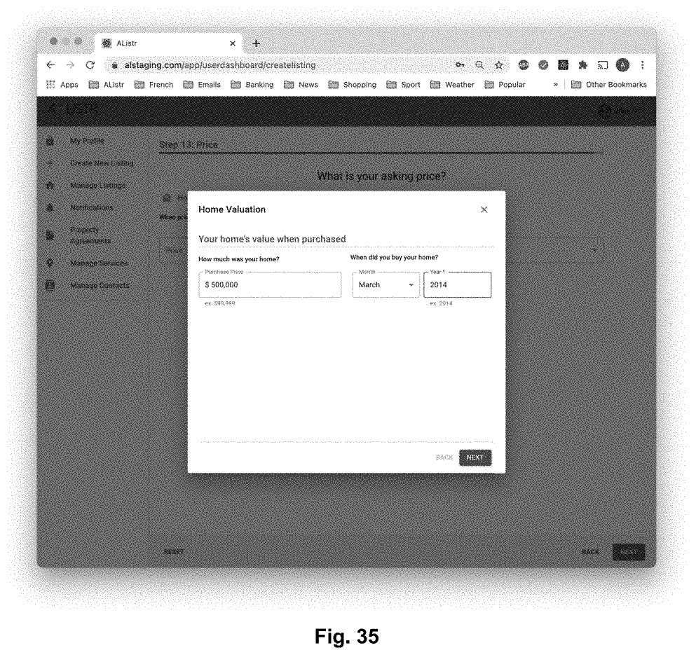

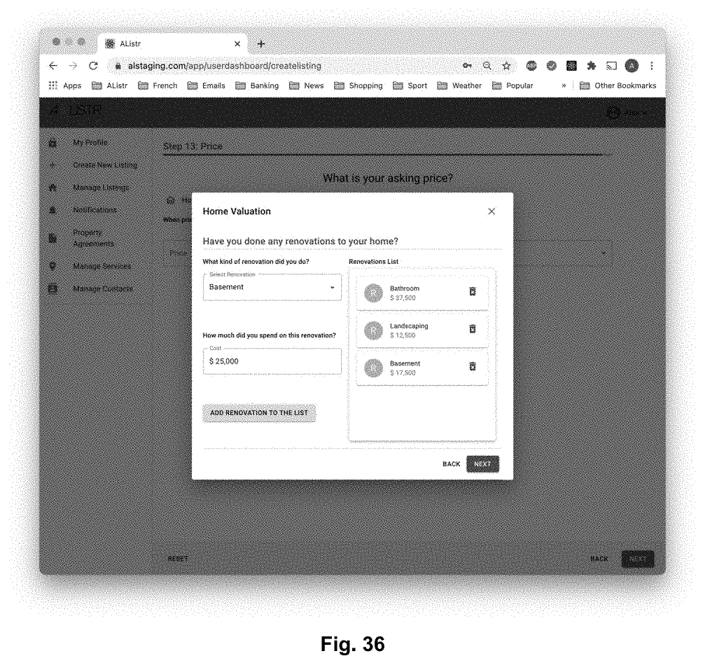

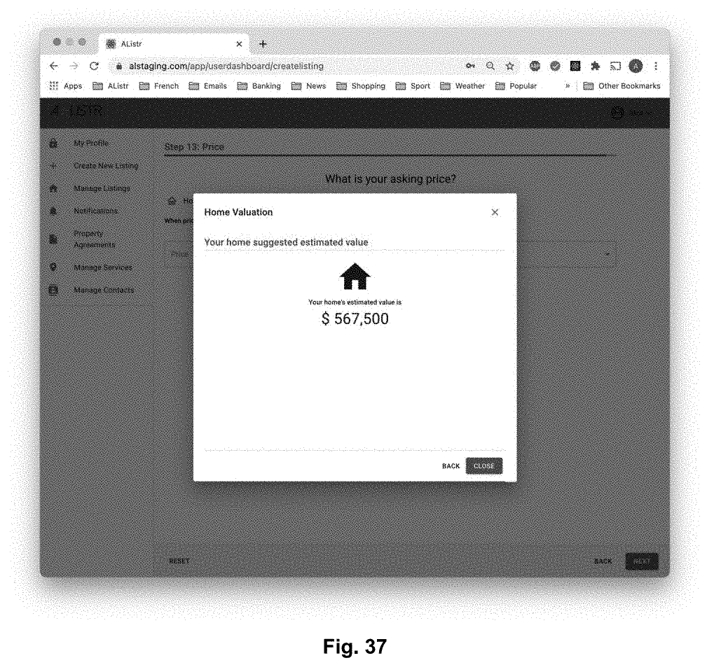

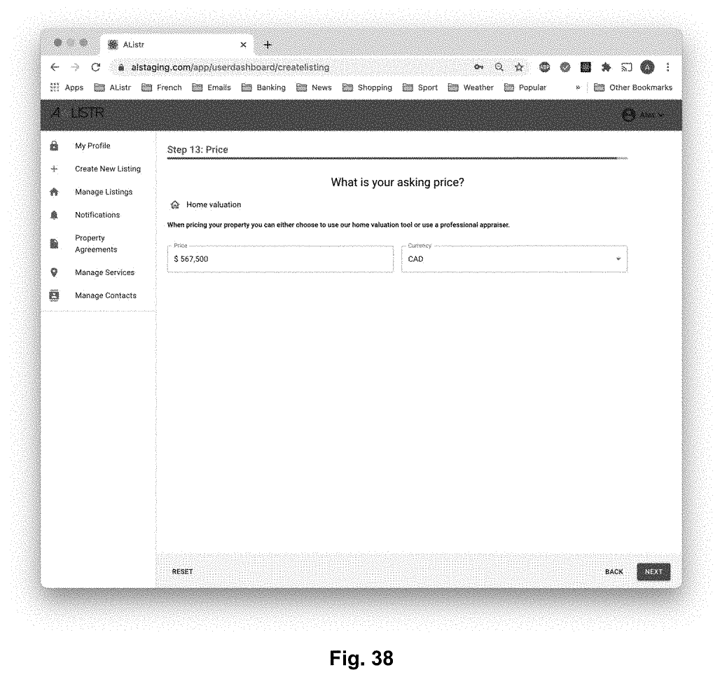

FIGS. 35 to 38 are screenshots of web pages for prompting entry, in a thirteenth step, information for generating a valuation of the property, including the input of the original purchase price (FIG. 35), and the value of any upgrades made over the course of ownership (FIG. 36). FIG. 37 is a screenshot of a web page displaying the estimated value of the property generated by the portal, and FIG. 38 is a screenshot of a web page prompting entry of the asking price.

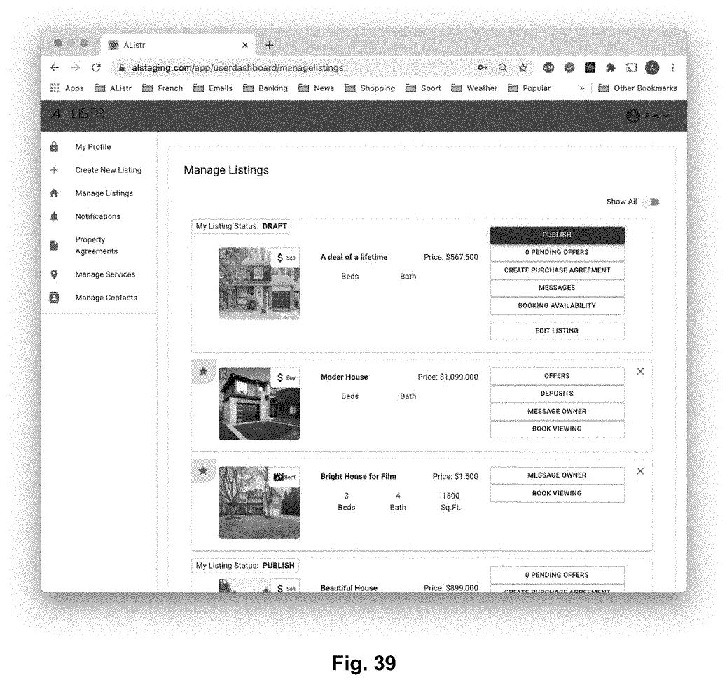

FIG. 39 is a screenshot of a web page with an exemplary seller dashboard that displays the status of real estate transactions being managed by a user using the platform of the present invention.

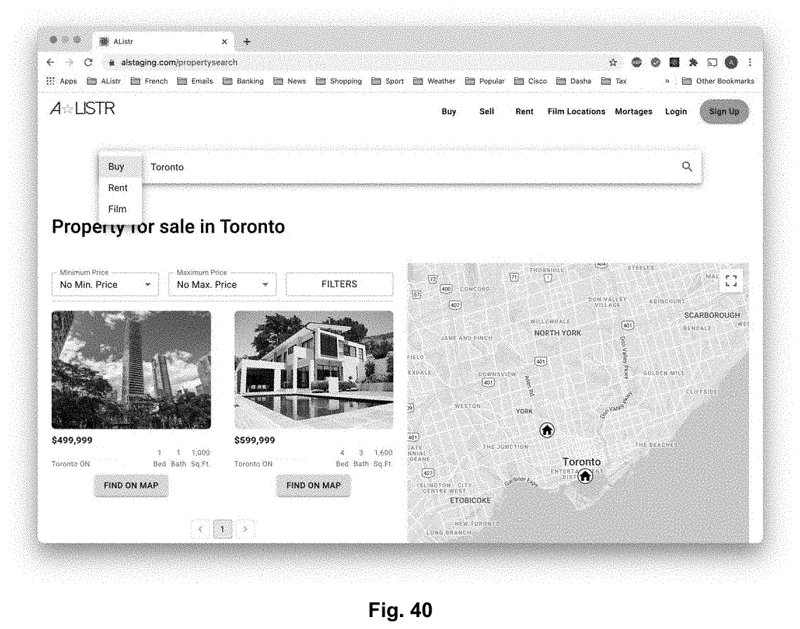

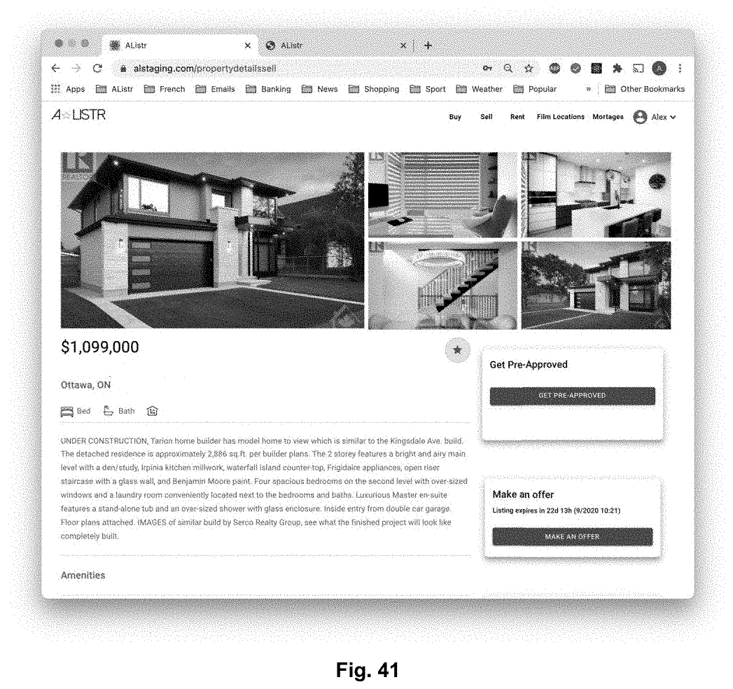

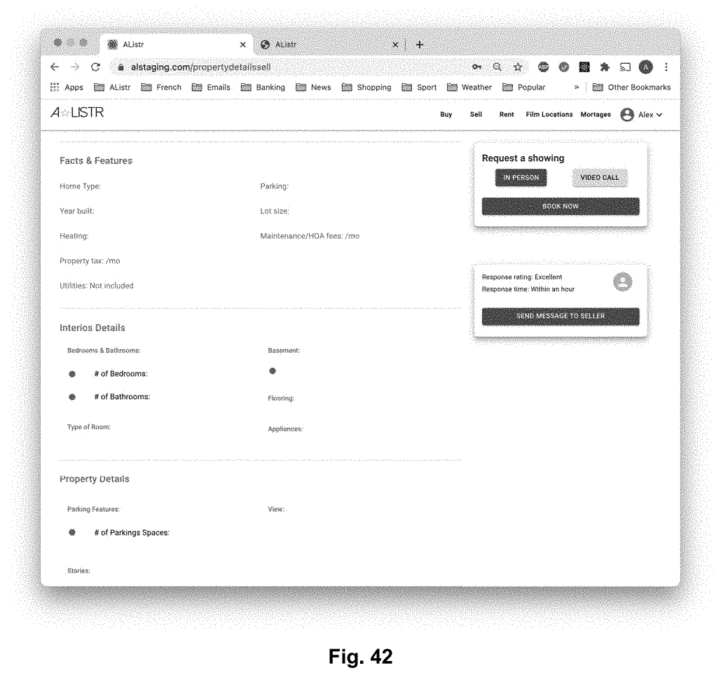

FIG. 40 is a screenshot of a web page displaying the initiation of a search for a real estate asset by a potential buyer. FIGS. 41 and 42 are screenshots of a web page displaying an available property selected by a buyer, showing links available to the buyer to engage the portal using the buyer dashboard to manage aspects of a real estate transaction, including initiating a process for obtaining a pre-approved mortgage, initiating contact with the seller of the property by sending messages or requesting a showing of the property, or submitting an offer on the property to the seller.

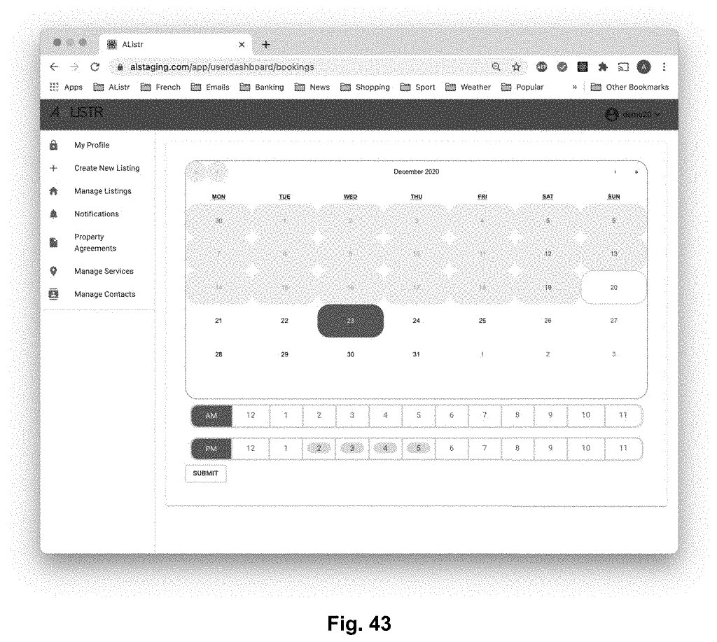

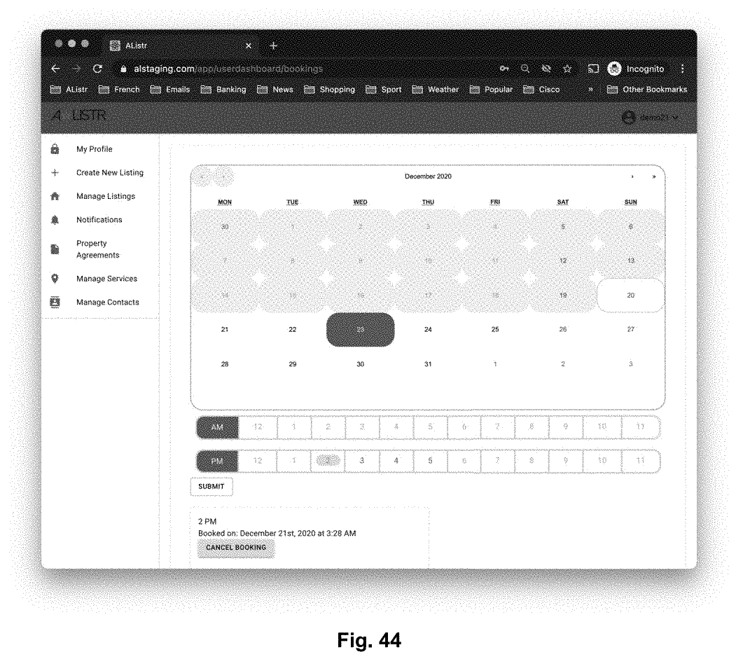

FIG. 43 is a screenshot of a web page displaying a calendar generated by the seller using the seller dashboard, indicating showing availability. The buyer can view the calendar using the buyer dashboard (FIG. 44), and request a showing, which can then be accepted by the seller via the seller dashboard.

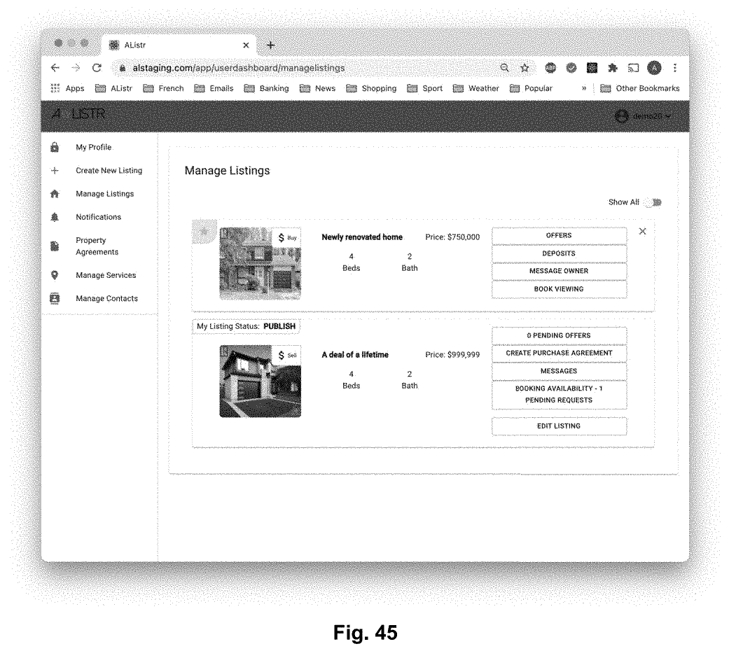

FIG. 45 is a screenshot of a web page displaying an exemplary seller dashboard, displaying the status of real estate transactions being managed by the seller using the platform of the present invention, including the pending request to book a showing of the property.

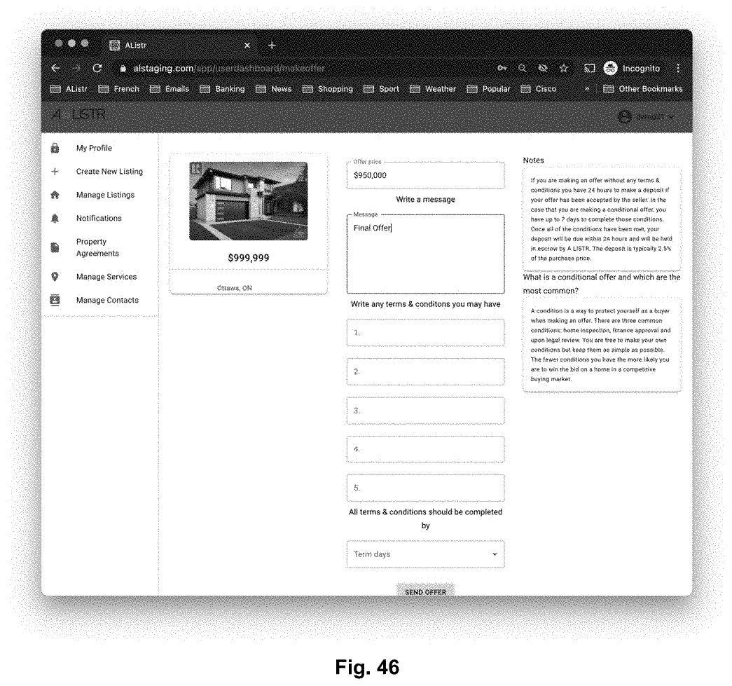

FIG. 46 is a screenshot of a web page displaying the offer portal of an exemplary buyer dashboard, prompting entry of information regarding the offer for purchase, including terms and conditions.

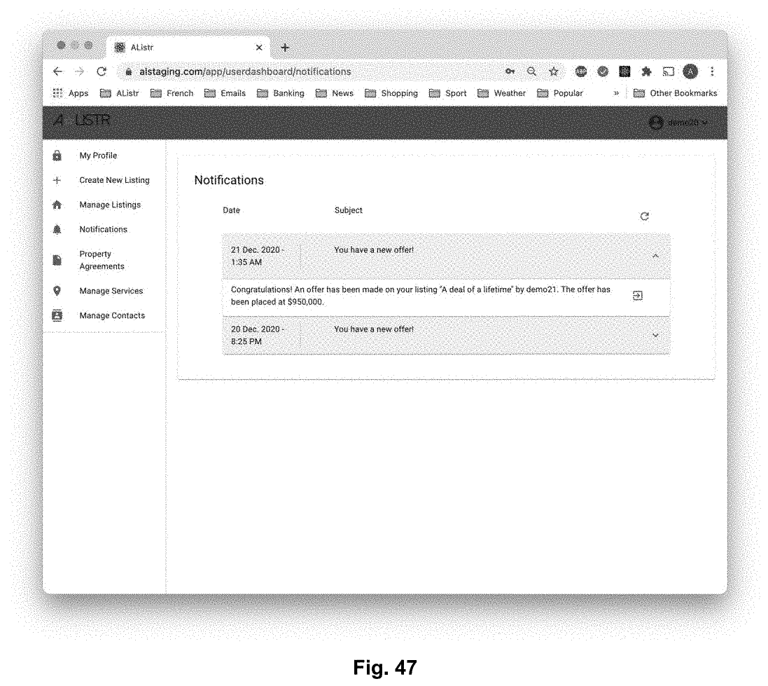

FIG. 47 is a screenshot of a web page displaying the notification page of a seller dashboard indicating notifications relating to existing offers on properties in the seller's portfolio.

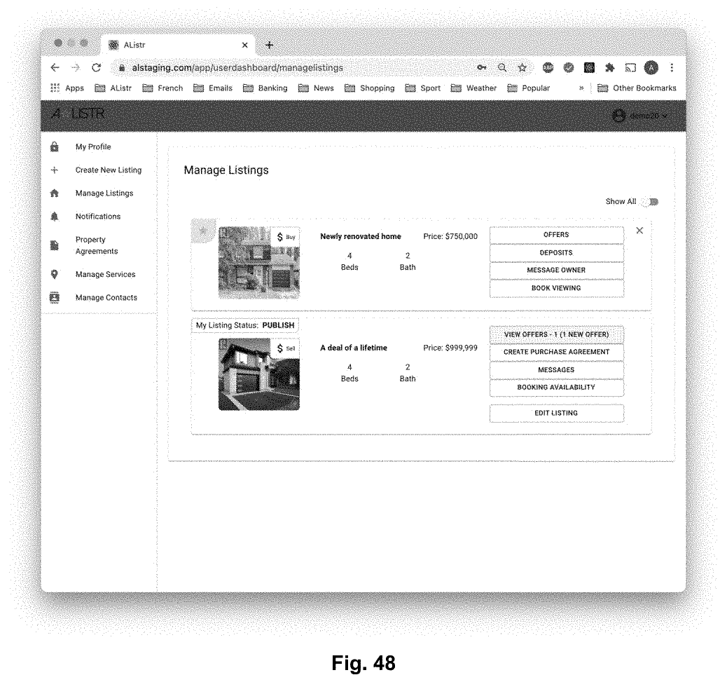

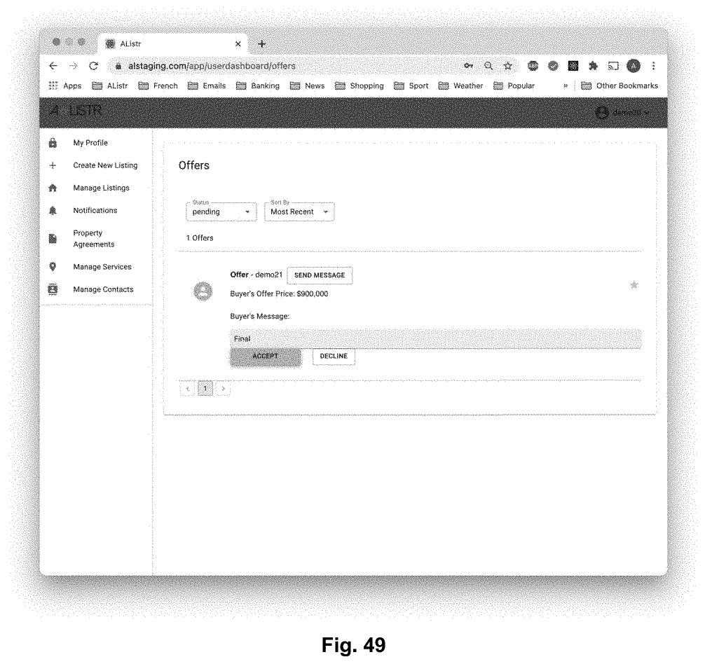

FIG. 48 is a screenshot of a web page displaying an exemplary seller dashboard, displaying the status of real estate transactions being managed by the seller using the platform of the present invention, including the pending offer, and FIG. 49 is a screenshot of a web page on the seller dashboard showing details of the pending offer, and input option for accepting or declining the offer.

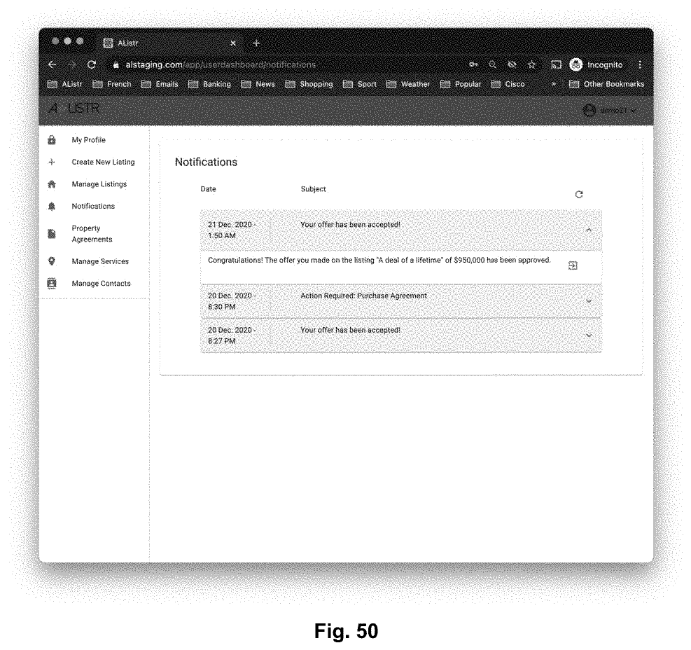

FIG. 50 is a screenshot of a web page displaying the notification page of a buyer dashboard indicating notifications relating to the status of the buyer's offer.

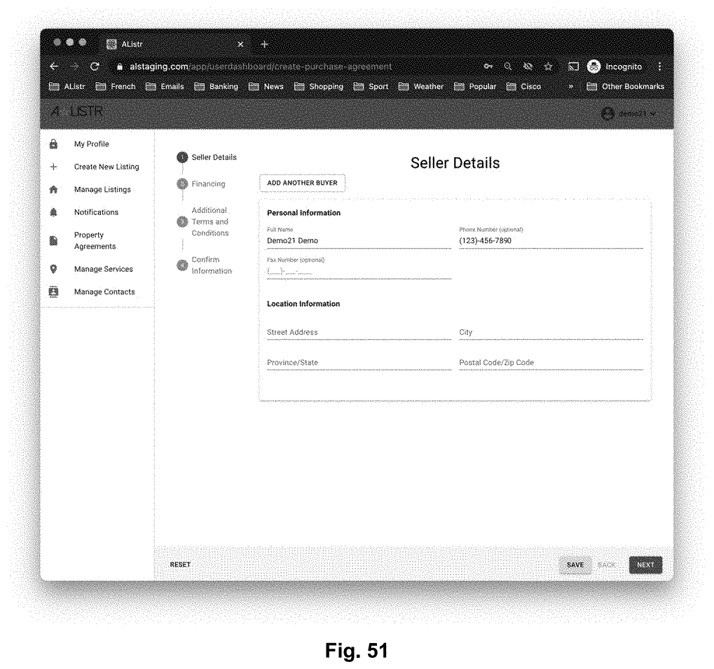

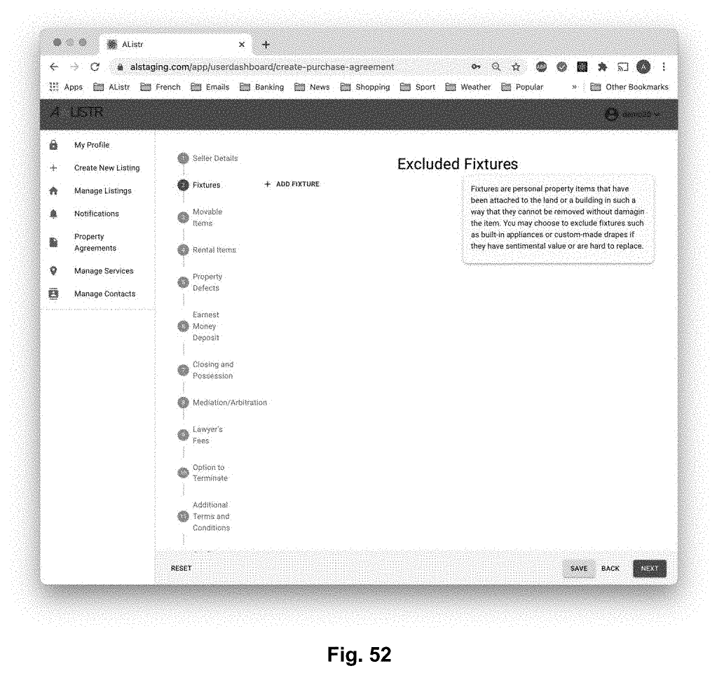

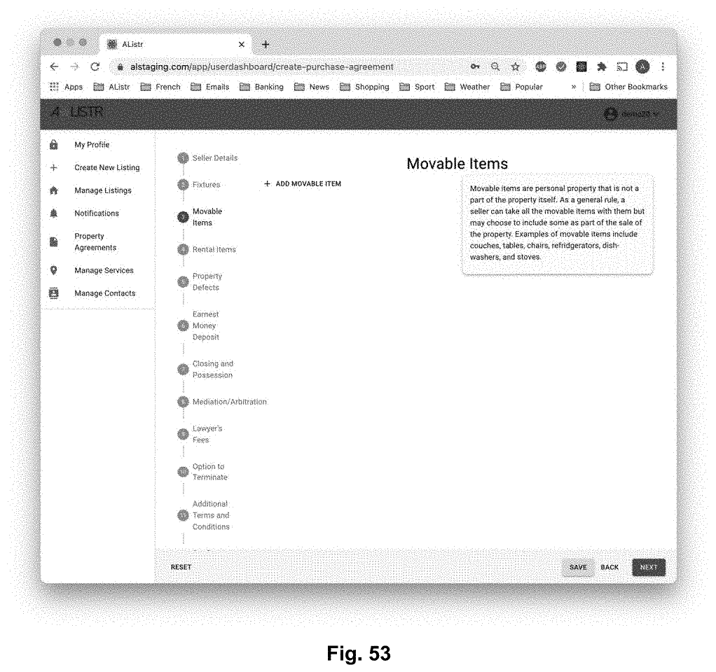

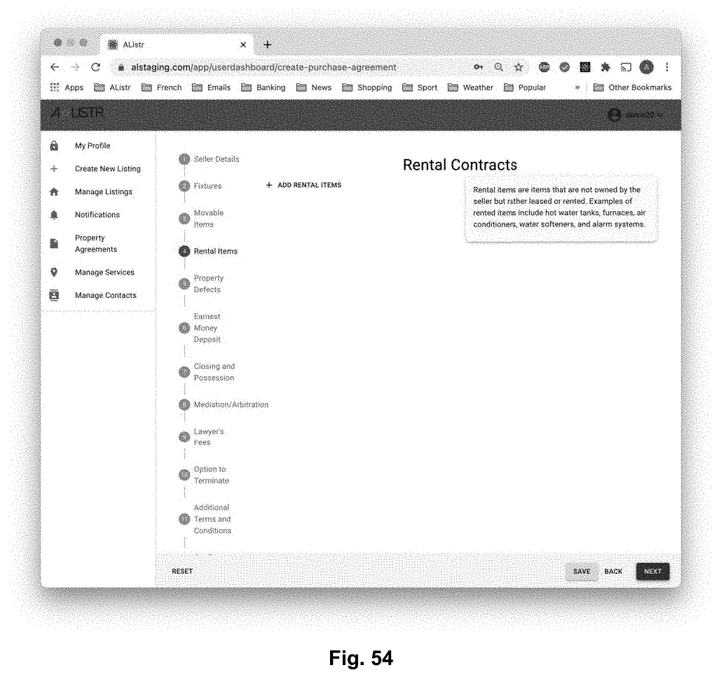

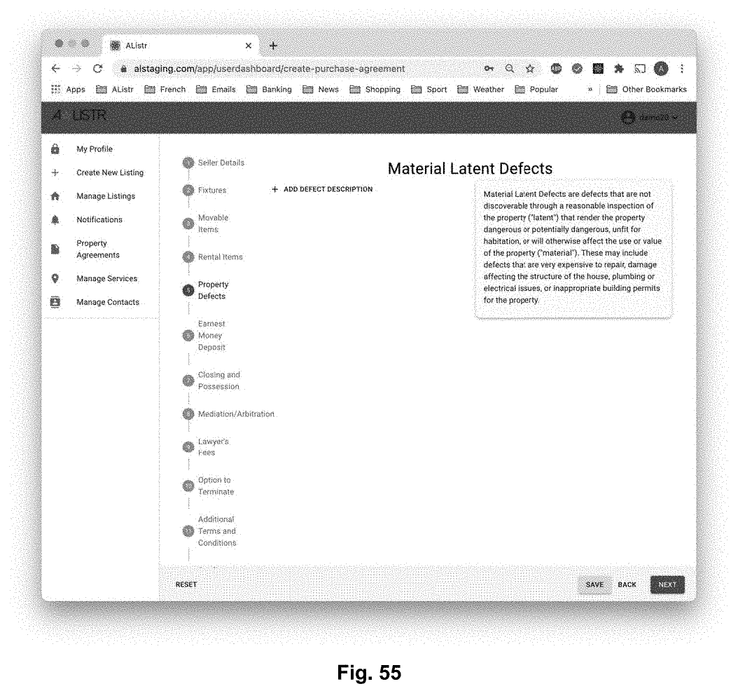

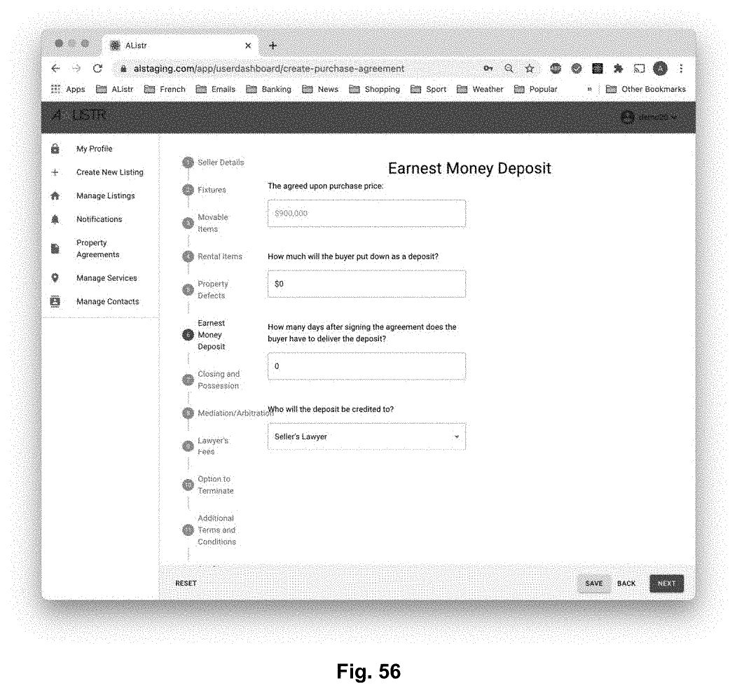

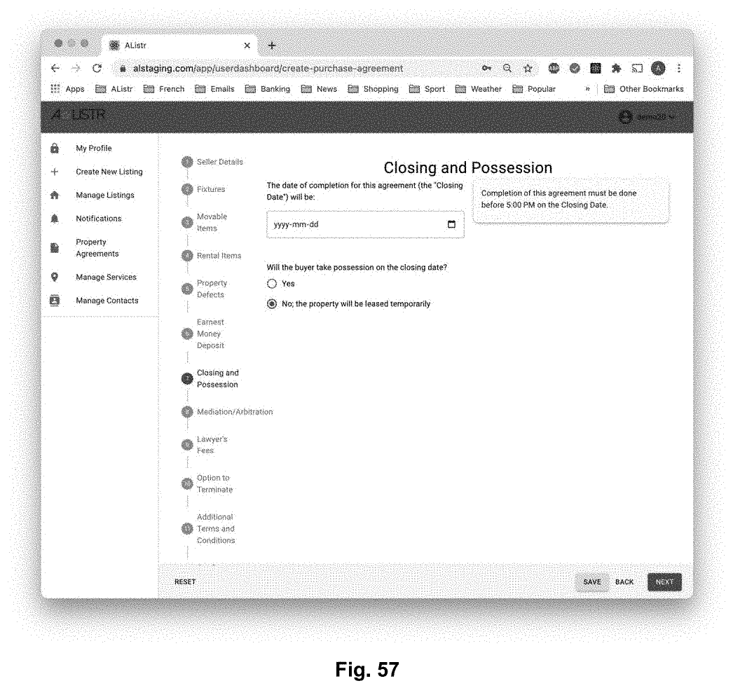

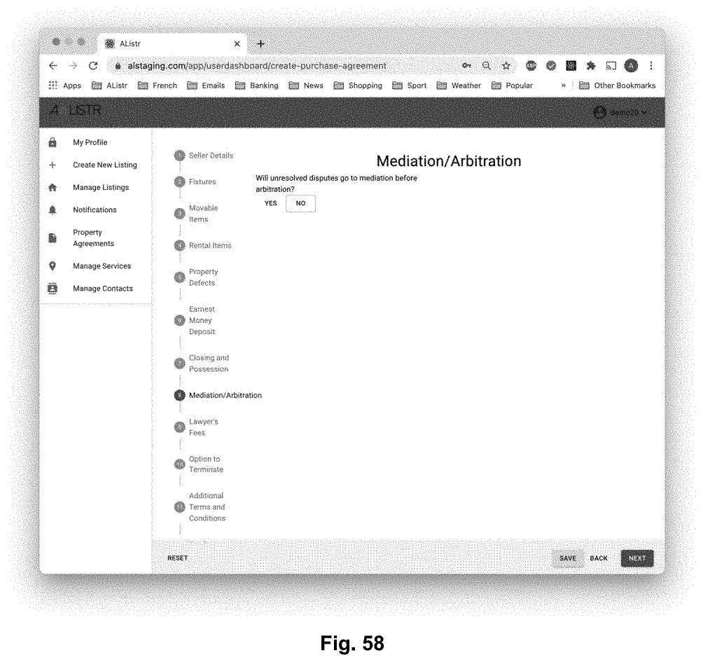

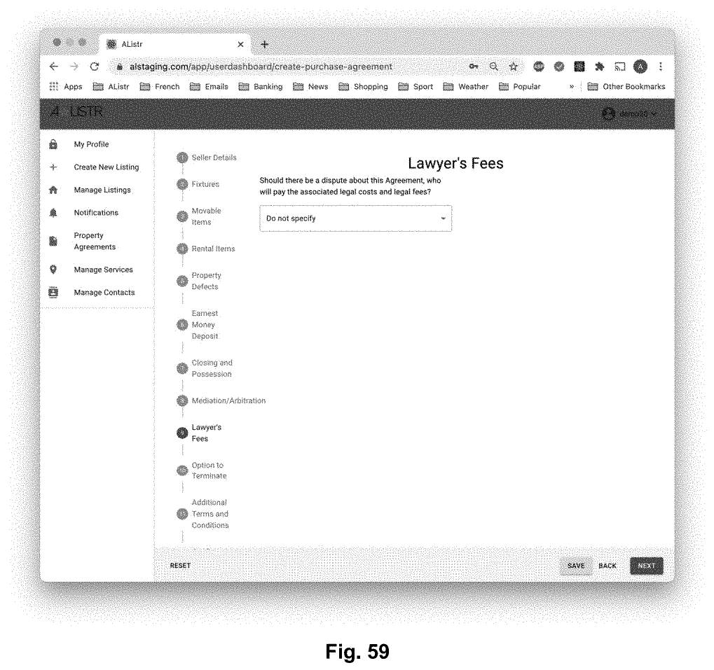

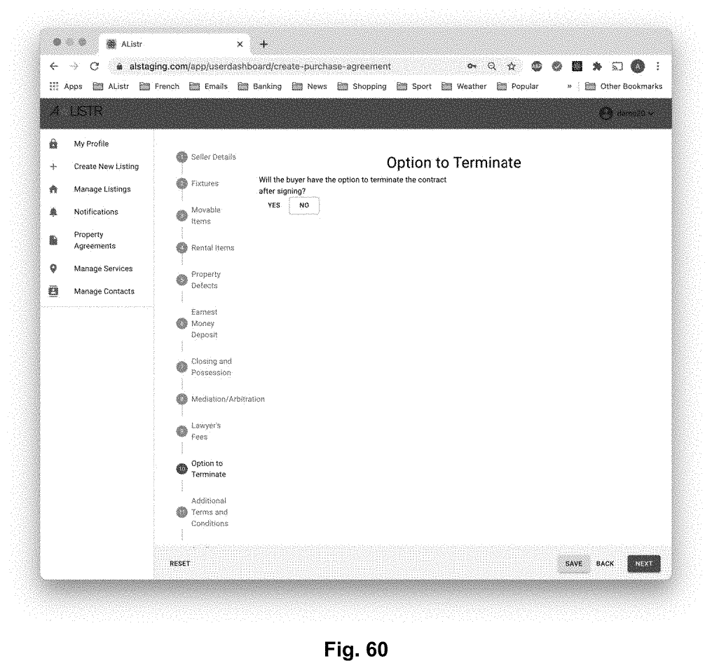

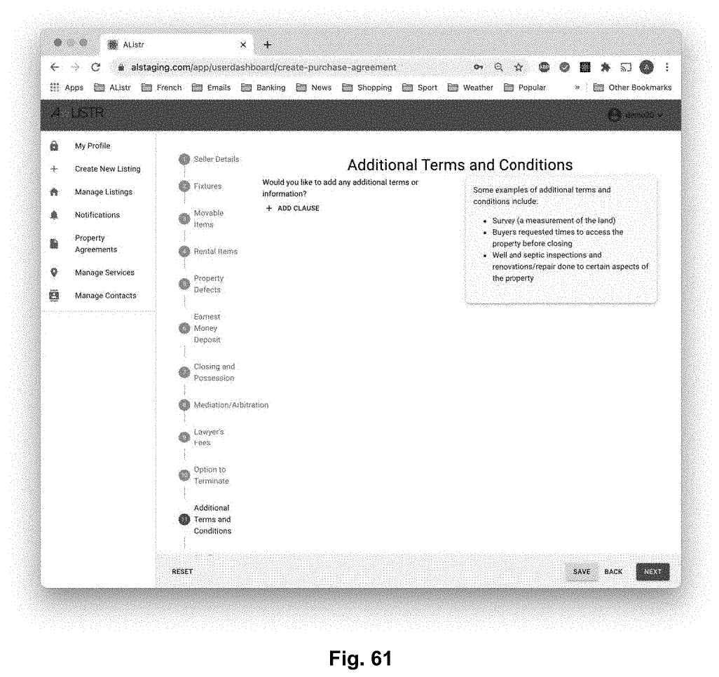

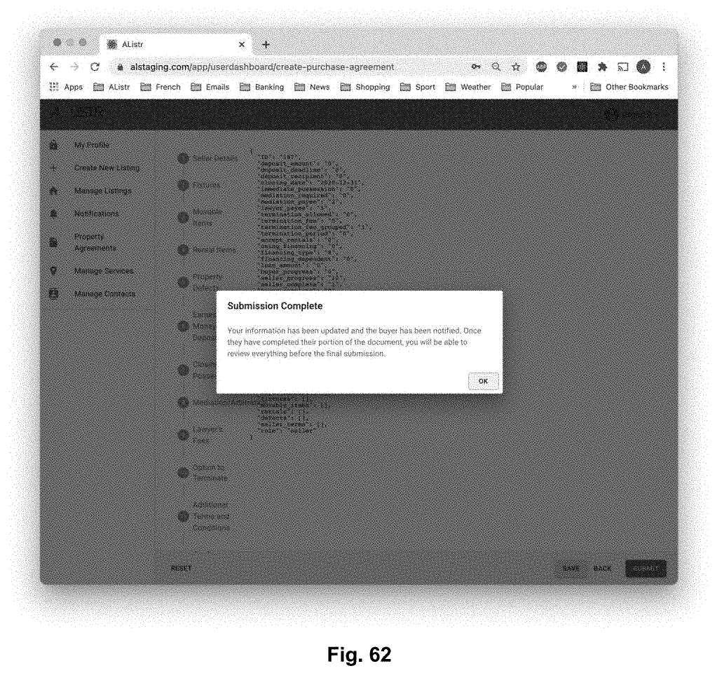

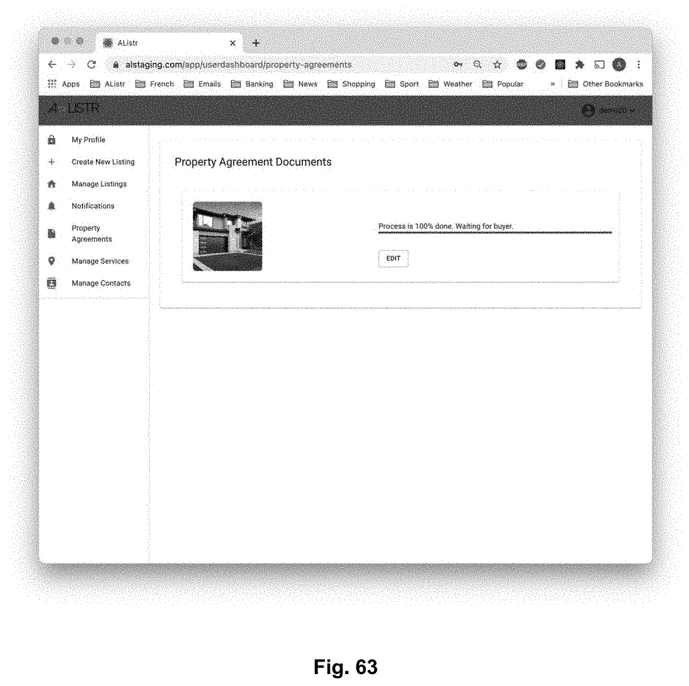

FIGS. 51 to 69 are screenshots of webpages displaying the step-by-step process for generating a purchase agreement using the portal of the present invention. All information is entered by the seller by entering the relevant information in response to prompts using the web portal, including the seller's personal information (FIG. 51). Additional information can also be entered using the web portal, including, for example, excluded fixtures (FIG. 52), movable items (FIG. 53), existing rental contract associated with the property (FIG. 54), material latent defects (FIG. 55), details regarding the buyer deposit (FIG. 56), closing and possession dates (FIG. 57), availability of mediation or arbitration (FIG. 58), responsibility for lawyer's fees, including in case of a dispute (FIG. 59), option for buyer termination (FIG. 60), and any other additional terms and conditions for completion of the transaction (FIG. 61). FIG. 62 is a screenshot of a web page displaying confirmation that the purchase agreement has been updated and completed by the seller and that the buyer has been notified, and FIG. 63 is a screenshot of the seller dashboard indicating the status of the purchase agreement process, indicating that the seller has completed their portion of the agreement and is waiting for a response from the buyer.

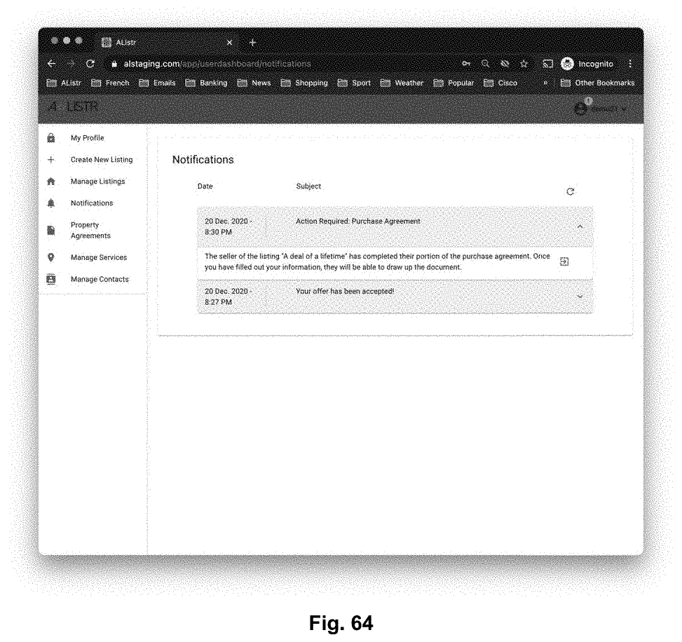

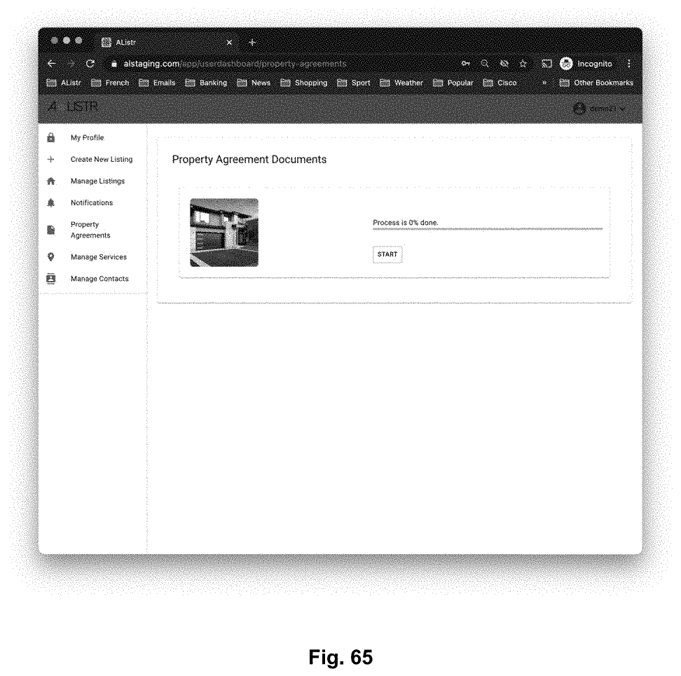

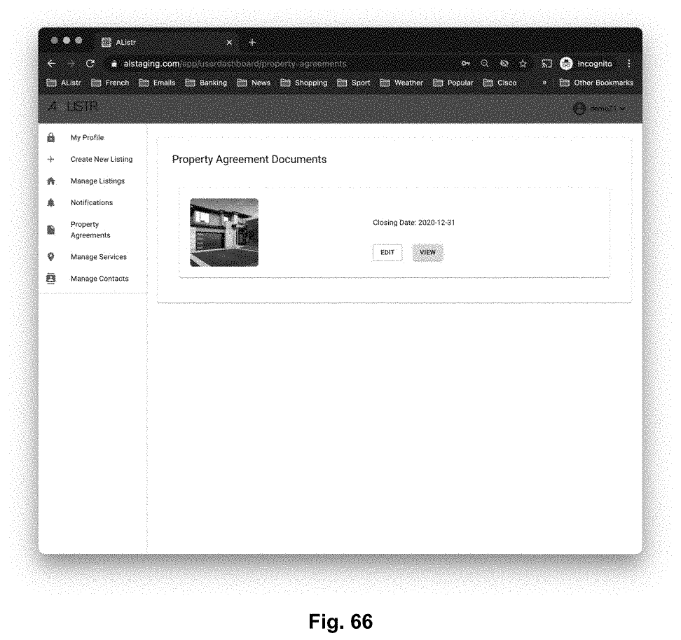

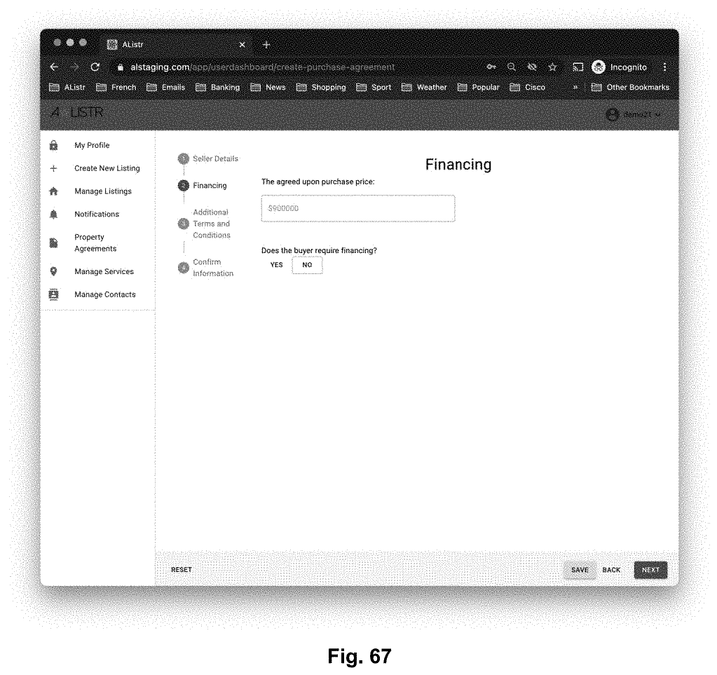

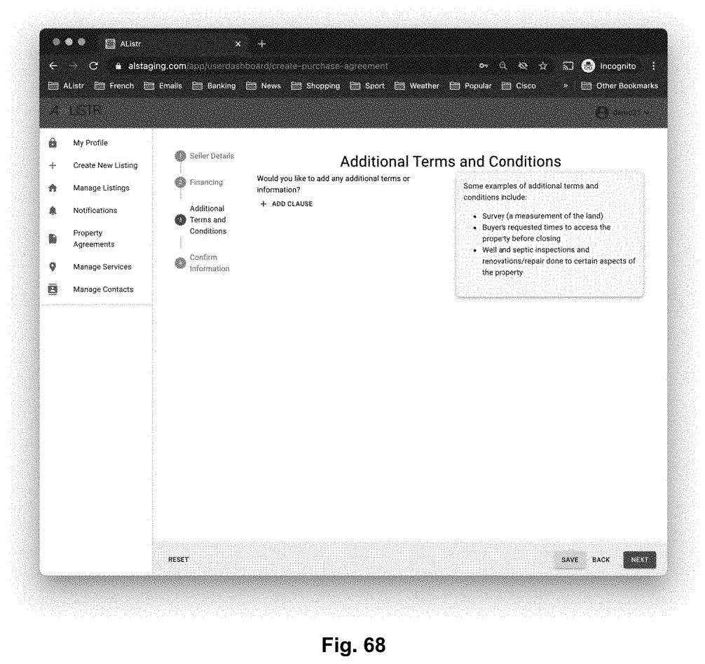

FIG. 64 is a screenshot of the notification page of the buyer dashboard, indicating that a purchase agreement has been generated and submitted to the buyer for completion, FIG. 65 is a screenshot of the seller dashboard indicating the status of the purchase agreement process, and FIG. 66 is a screenshot of the seller dashboard providing access to the property agreement for editing. All information is entered into the purchase agreement by the buyer by entering the relevant information in response to prompts using the web portal, including financing information (FIG. 67), and any additional terms and conditions as set out by the buyer (FIG. 68).

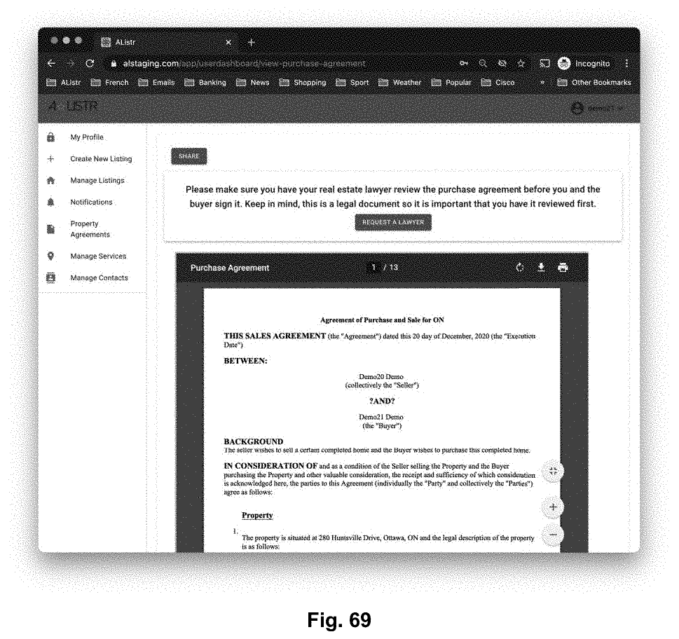

FIG. 69 is a screenshot of the web page that provides a pdf copy of the final purchase agreement generated by the seller and buyer.

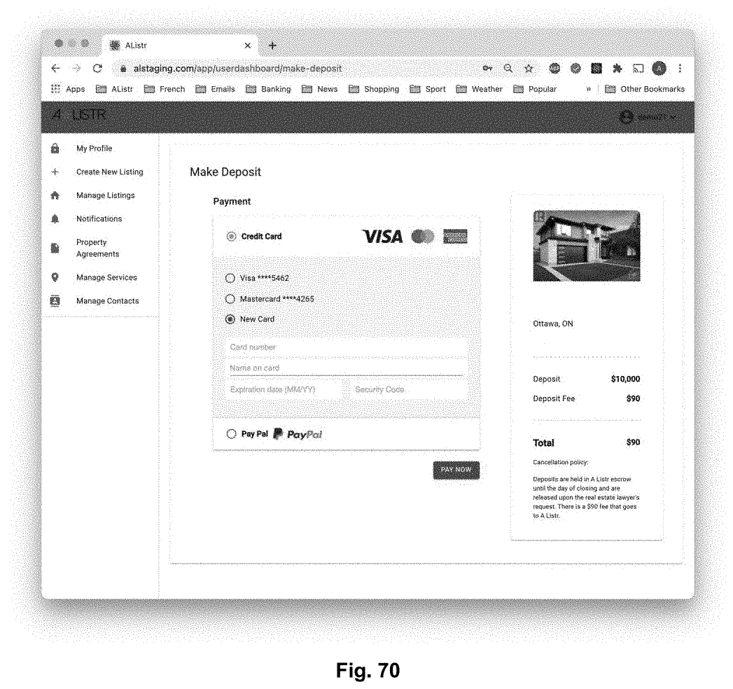

FIG. 70 is a screenshot of the payment page where the buyer can enter the payment information to make a deposit.

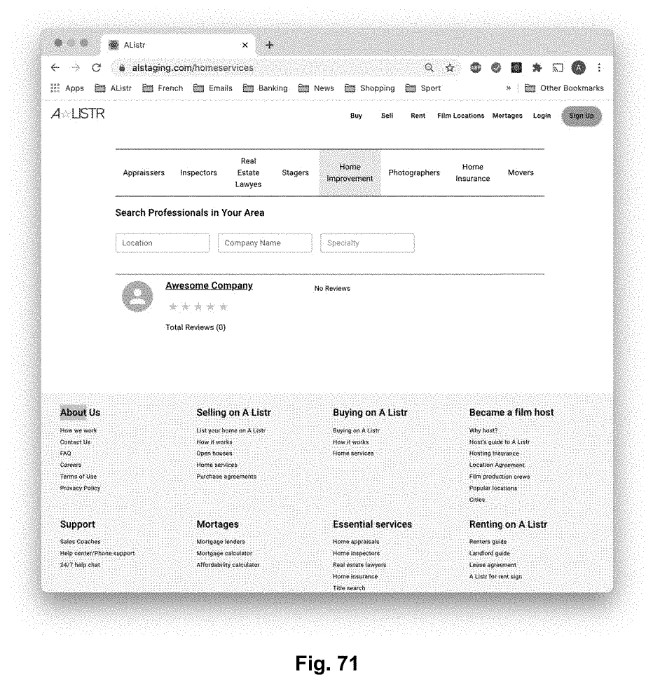

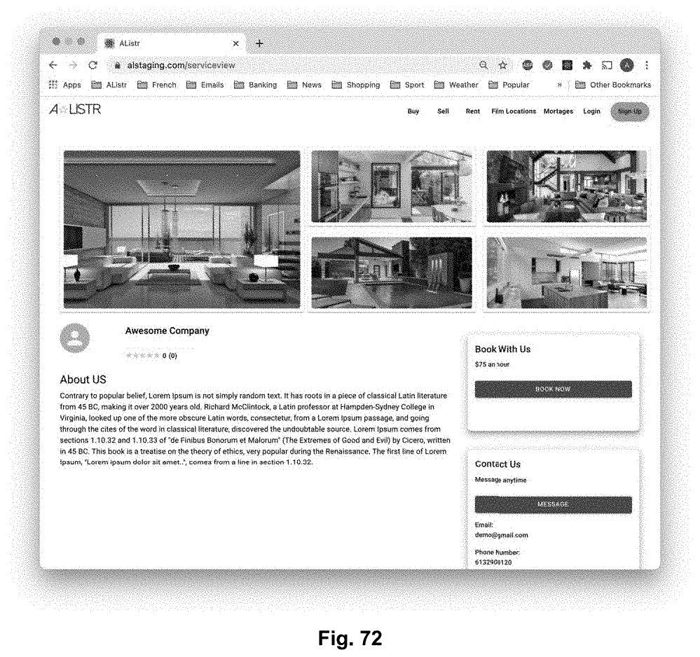

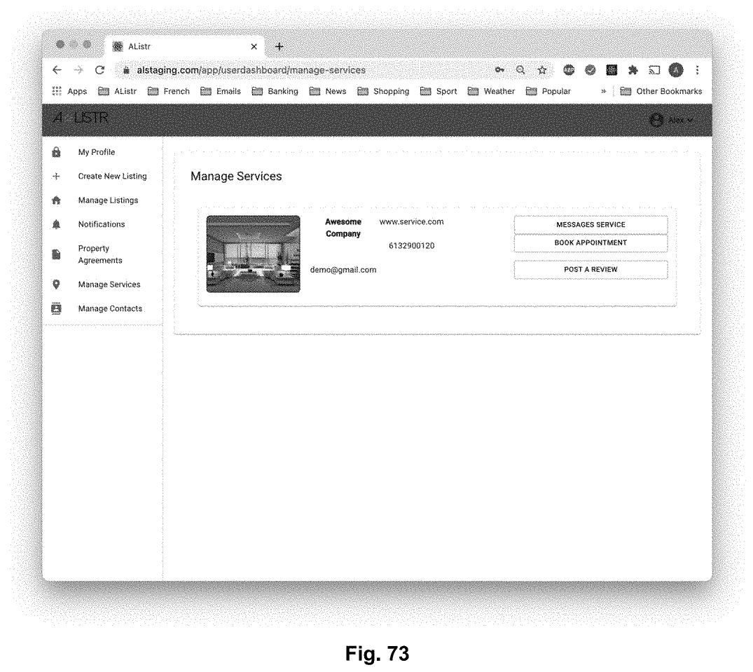

FIGS. 71 to 73 are screenshots of webpages displaying the web portal accessing the information regarding service providers maintained on the service database. FIG. 71 is a screenshot of the search page through which a user accesses the database by selecting the type of service required and browsing options provided. FIG. 72 is a screenshot of a web page displaying a service provider selected by a buyer, showing links available to the buyer, using the buyer dashboard, for engaging the service provider. FIG. 73 is a screenshot of a web page of the buyer dashboard by which the buyer manages engagement and interaction with the service provider.

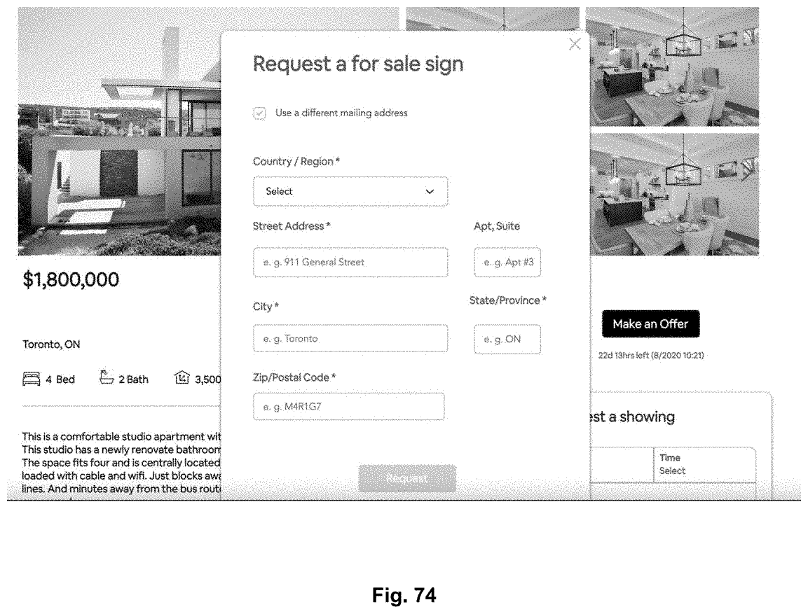

FIG. 74 is a screenshot of a web page displaying the web portal for by which the seller can request a For Sale sign from the service database using their seller dashboard.

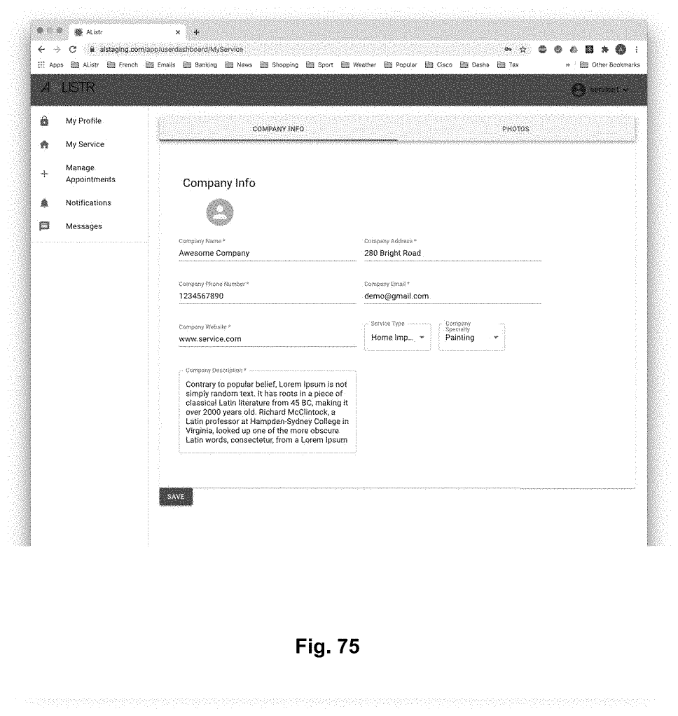

FIG. 75 is a screenshot of a web page on the service provider dashboard that can be accessed by a service provider to generate a service provider listing, including company name and contact information, as well as the list of service provided. The service provider listing, once generated, is maintained on the service database and can be accessed upon queries from users of the web portal.

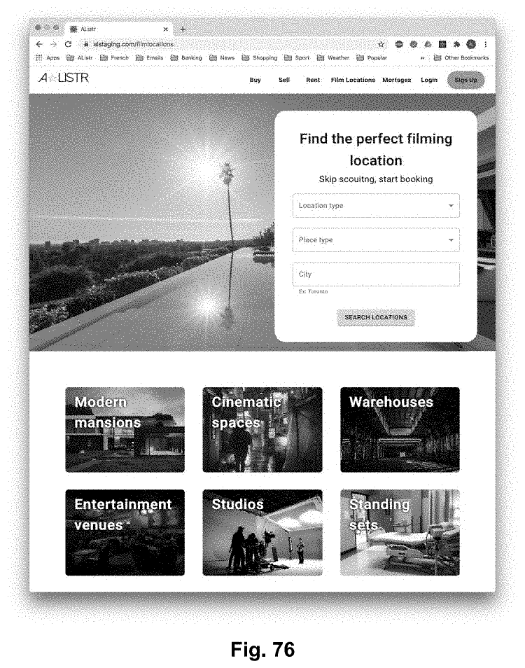

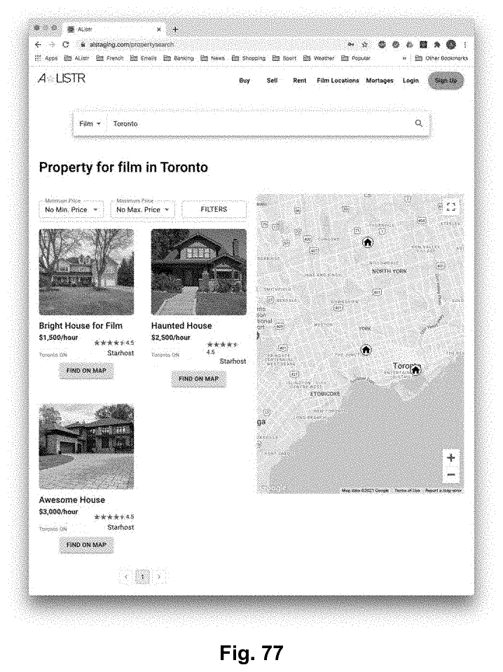

FIGS. 76 and 77 are screenshots of web pages relating to the filming location rental search service in accordance with an embodiment of the invention, containing a list a rental properties that available for use as filming locations, and which are maintained on the property database.

We claim:

1. A web based real estate transaction management platform comprising:
a property database containing information regarding one or more property listings, wherein the property listings include properties for sale, properties for rent or both;
a service database containing information regarding one or more real estate related services,
wherein the property database and the service database are maintained on a central real estate transaction management computer system;
at least one user module connected to the property database and the service database via a computer network for access by a user via a graphical user interface on a web page displayed on a remote computer, wherein the user is a seller, a buyer or a service provider;
wherein the user module comprises at least one seller dashboard configured to display on, the graphical user interface, information relating to the current status of seller driven real estate related transaction events in progress, and at least one buyer dashboard configured to display on the graphical user interface information relating to the current status of buyer driven real estate related transaction events in progress;
wherein the computer processor is operative with the property database, the service database, and the at least one user module to process inputs received via the at least one user module and to process communications via the computer network between the at least one user module and the databases;
wherein the platform is configured to facilitate communication between the seller and the buyer over the computer network, and
wherein the seller is a vendor or a landlord, and wherein the buyer is a purchaser or a renter.

2. The platform of claim 1, wherein the seller can modify the property database by adding, removing or modifying a property listing on the property database using the seller module.

3. The platform of claim 1, wherein the buyer can query the property database using the buyer dashboard by inputting one or more criteria of interest to identify one or more selected property listings in the property database that correlate to the one or more criteria.

4. The platform of claim 1, wherein the user module further comprises at least one service provider dashboard configured to display on the graphical user interface information relating to the current status of service provider driven real estate related transaction events in progress;
wherein the service provider uses the service provider dashboard to input information regarding one or more services provided into the service provider database, and to correspond with the buyer or seller who is requesting a service.

5. The platform of claim 4, wherein the service provider is a financial service provider, a legal service provider, a contractor, a tradesperson such as plumbers, electricians, painters, roofer, a utility service provider, a moving company, a vehicle rental company, a provider of marketing resources such as photographers, For Sale sign suppliers, stagers, a landscaping company, a home inspector, and an insurance provider.

6. The platform of claim 1, wherein the information regarding the property listings includes one or more of type of property, location, size, price, amenities, neighborhood, parking and accessibility, number and type of rooms, landscaping, interior finishing, exterior finishing, photos, taxes, and fees, and wherein upon request from the user, the platform provides the user with information regarding area, location or neighbourhood of the property.

7. The platform of claim 1, wherein the information regarding one or more real estate related services includes one or more of service type, availability, and costs.

8. The platform of claim 1, wherein the buyer driven real estate related transaction events include one or more of correspondence with the seller or service provider, requests for property showing appointment, requests for mortgage pre-approval, submission of an offer for purchase, requests for service provider recommendations, requests for engagement with a service provider, management of service provider engagements, requests for mortgage.

9. The platform of claim 1, wherein the seller driven real estate related transaction events include one or more of creation and management of a property listing, correspondence with the buyer or service provider, management of requests for property showing appointment, acceptance of an offer for purchase, requests for engagement with a service provider, management of service provider engagements, requests for mortgage.

10. The platform of claim 1, wherein, upon request from the user, the platform provides recommendations regarding property valuation.

11. The platform of claim 1, wherein, upon request from the user, the platform provides recommendations regarding service providers relevant to a real estate transaction, optionally wherein the recommended service providers are ranked in order of client ratings.

12. The platform of claim 1, wherein, upon request from the user, the platform provides the seller with recommendations regarding property improvements to maximize net proceeds upon sale or rent of the property, optionally with quotations regarding costs for implementing the recommendations.

13. The platform of claim 1, wherein, upon request from the user, the platform provides the seller with marketing guidelines or strategies to assist with making the property more attractive to potential buyers, and optionally provides recommendations regarding adjustments to be made to the listing to improve selling appeal.

14. The platform of claim 1, wherein, upon request from the user, the platform provides the seller with options for delivery of sales-related signs to the property.

15. The platform of claim 1, wherein, upon request from the user, the platform provides the seller with analytics and information about the activity on a property listing.

16. The platform of claim 1, wherein, upon request from the user, the platform provides an automated calendar to facilitate scheduling of visits to the property.

17. The platform of claim 1, wherein, upon request from the user, the platform provides a buyer with one or more of a personalized determination as to purchase affordability, recommendations as to appropriate properties, considering their financial information.

18. The platform of claim 1, wherein, upon request from the user, the platform provides the buyer with mortgage quotes from financial institutions, and/or suggestions regarding financial services including one or more of wealth management, car loans, budgeting tools, RRSPs, RESPs, and TFSAs.

19. The platform of claim 1, wherein, upon request from the user, the platform provides the buyer with lists of properties meeting one or more criteria entered by the buyer, wherein the properties are optionally listed in order of how well the property matches the criteria.

20. The platform of claim 1, wherein, upon request from the user, the platform tracks and manages the buyer's interest in the properties reviewed by the buyer, and provides the seller with information as to buyers' tracked interests.

21. The platform of claim 1, wherein, upon request from the user, the platform facilitates completion of a property transaction without a lawyer.

22. The platform of claim 1, wherein, upon request from the user, the platform ensures that the buyer has secured financing to fund the property purchase.

23. The platform of claim 1, wherein, upon request from the user, the platform ensures that all conditions, joint conditions and deal-specific conditions between the buyer and the seller, stated on a purchase agreement, are agreed upon and met, before the transaction can close.
